(19) United States
(12) Patent Application Publication
(10) Pub. No.: US 2004/0088780 A1
(43) Pub. Date: May 13, 2004

(54) Personal protection system and method for using a personal protection system

(76) Inventor: Shlomo Bachar, New York, NY (US)

Correspondence Address: KENYON & KENYON, ONE BROADWAY, NEW YORK, NY, 10004, US

(21) Appl. No.: 10/290,658

(22) Filed: Nov. 8, 2002

(51) Int. Cl. A62B 17/00; A41D 13/00

(52) U.S. Cl. 2/457

(57) ABSTRACT

A personal protection system is provided, the system including a backpack configured to couple to a user, the backpack including a system garment fixedly coupled to the backpack. The system garment of the personal protection system includes at least one system unit operable to at least partially aid the user in at least one of a biological hazard, a nuclear hazard, a chemical hazard, and a radiological hazard.

### FIELD OF THE INVENTION

The present invention relates to a personal hazard protection system and method for protecting a user from a hazard, such as a biological, nuclear, chemical, and/or radiological hazard.

### BACKGROUND INFORMATION

In many situations, a user may need to be protected within a hazard zone, such as a biological, nuclear, chemical, and/or radiological hazard zone. Adequate protection may be necessary because these hazards may cause severe health problems in a short period of time.

### SUMMARY OF THE INVENTION

It is an object of the present invention to provide a personal protection system, including a backpack configured to couple to a user, and a system garment fixedly coupled to the backpack, in which the system garment includes at least one system unit operable to at least partially aid the user in at least one of a biological hazard, a nuclear hazard, a chemical hazard, and a radiological hazard.

It is another object of the present invention to provide the personal protection system described above, in which the backpack includes at least one harness strap configured to couple to the user.

It is still another object of the present invention to provide the personal protection system described above, in which the at least one system unit includes at least one of a Nuclear-Biological-Chemical escape mask, a smoke escape mask, a nuclear gas mask, a gas mask filter, a protective suit, a pair of protective gloves, a pair of protective booties, a roll of tape, a flashlight, radiation blocking pills, at least one gas detection device, at least one radiation detection device, a water purifier, a first-aid kit, a two-way radio device, a cell phone, a rescue whistle, at least one light-stick, a compass, an AM/FM radio, a safety horn, at least one writing utensil, waterproof matches, a utility belt, a parachute, and a portable drinking supply.

It is yet another object of the present invention to provide the personal protection system described above, in which the portable drinking supply includes a “Camel-Bak” drinking supply.

It is still another object of the present invention to provide the personal protection system described above, further including a protective shroud, in which the backpack further includes a pouch configured to contain the protective shroud.

It is yet another object of the present invention to provide the personal protection system described above, in which at least a portion of the protective shroud is fixedly coupled to one of the backpack and the system garment.

It is still another object of the present invention to provide the personal protection system described above, in which the protective shroud is provided with an identifying color to identify a type of equipment contained within the backpack.

It is yet another object of the present invention to provide the personal protection system described above, in which the protective shroud is provided to identify an institution.

It is still another object of the present invention to provide the personal protection system described above, in which the institution includes at least one of the Federal Bureau of Investigation and the Center for Disease Control.

It is yet another object of the present invention to provide the personal protection system described above, further including an external equipment fastening arrangement configured to detachably couple to at least one piece of external equipment.

It is still another object of the present invention to provide the personal protection system described above, in which the external equipment includes a bag.

It is yet another object of the present invention to provide the personal protection system described above, further including a transceiver arrangement configured to wirelessly communicate information with at least one remote location.

It is still another object of the present invention to provide the personal protection system described above, in which the transceiver is configured to transmit status information to the at least one remote location.

It is yet another object of the present invention to provide the personal protection system described above, in which the status information includes at least one of the geographical location of the user, life signs of the user, a hazard level, and emergency information.

It is still another object of the present invention to provide the personal protection system described above, in which the status information includes information concerning a progress sequence of preparing the personal protection system.

It is yet another object of the present invention to provide the personal protection system described above, in which the transceiver arrangement is configured to receive information concerning a geographical location of the personal protection system from at least one GPS satellite.

It is still another object of the present invention to provide the personal protection system described above, further including a protective suit fixedly coupled to the system garment.

It is yet another object of the present invention to provide the personal protection system described above, further including a system unit bag coupled to the system garment.

It is still another object of the present invention to provide the personal protection system described above, in which the bag is detachably coupleable to the system garment.

It is yet another object of the present invention to provide the personal protection system described above, in which the system unit bag includes at least one compartment for carrying at least one of the system units.

It is still another object of the present invention to provide the personal protection system described above, in which at least one of the compartments is vacuum sealed.

It is still another object of the present invention to provide a transceiver arrangement, including an antenna arrangement; and a processing arrangement communicatively coupled to the antenna arrangement, the processing arrangement configured to wirelessly communicate information with at least one remote location; in which a transmission is started in accordance with at least one status switch of a personal protection system.

It is yet another object of the present invention to provide the transceiver arrangement described above, in which the processing arrangement is configured to transmit status information to the at least one remote location via the antenna arrangement.

It is still another object of the present invention to provide the transceiver arrangement described above, in which the status information includes at least one of the geographical location of the user, life signs of the user, a hazard level, and emergency information.

It is yet another object of the present invention to provide the transceiver arrangement described above, in which the status information includes information concerning a progress sequence of preparing the personal protection system.

It is still another object of the present invention to provide the transceiver arrangement described above, in which the processing arrangement is configured to receive information concerning a geographical location of the personal protection system from at least one GPS satellite via the antenna arrangement.

It is yet another object of the present invention to provide a method of protecting a user from at least one of a biological hazard, a chemical hazard, a nuclear hazard, and a radiological hazard, the method including providing a user with a personal protection system, the personal protection system including a system garment fixedly coupled to the backpack, the system garment including at least one system unit operable to at least partially aid the user in the at least one of the biological hazard, the chemical hazard, the nuclear hazard, and the radiological hazard, reconfiguring the system garment from a space-saving state to an unpackaged state, reconfiguring the system garment from the unpackaged state to a wearable state, and supplying the user with the at least one system unit.

It is still another object of the present invention to provide the method described above, in which the at least one system unit includes at least one of a Nuclear-Biological-Chemical escape mask, a smoke escape mask, a nuclear gas mask, a gas mask filter, a protective suit, a pair of protective gloves, a pair of protective booties, a roll of tape, a flashlight, radiation blocking pills, at least one gas detection device, at least one radiation detection device, a water purifier, a first-aid kit, a two-way radio device, a cell phone, a rescue whistle, at least one light-stick, a compass, an AM/FM radio, a safety horn, at least one writing utensil, waterproof matches, a utility belt, a parachute, and a portable drinking supply.

It is yet another object of the present invention to provide the method described above, in which the step of supplying the user with the at least one system unit includes the following sub-steps: supplying the user with a protective mask; supplying the user with a protective suit; supplying the user with a pair of gloves and a pair of booties; and taping the gloves and the booties to the protective suit.

It is still another object of the present invention to provide the method described above, in which the sub-steps further include the sub-step of providing the user with a utility belt.

It is yet another object of the present invention to provide the method described above, in which the utility belt includes a drinking supply.

It is still another object of the present invention to provide a gas mask for filtering an atmosphere, including at least two contaminant filters; and a selection dial for selecting a combination of the contaminant filters; in which the combination includes at least one of the contaminant filters, and the atmosphere is filtered through the combination of contaminant filters.

It is yet another object of the present invention to provide the gas mask described above, further including an adjustable light source manually pivotable into at least one position.

It is still another object of the present invention to provide the gas mask described above, further including a communications jack; and a headphone and speaker arrangement one of detachably and permanently connected to the communications jack in an airtight manner.

It is yet another object of the present invention to provide the gas mask described above, further including a drinking supply jack configured to connect to a portable drinking supply in an airtight manner.

It is still another object of the present invention to provide a protective garment, including a protective suit, including booties, gloves, and a mask; in which the booties, the gloves, and the mask are fixedly secured to the protective suit.

It is yet another object of the present invention to provide the protective suit described above, further including at least one adjustable strap to adjust at least one of the booties and the gloves.

### BRIEF DESCRIPTION OF THE DRAWINGS

FIG. 1a is a front view of an exemplary personal protection system 100 according to the present invention.

FIG. 1b is a back view of an exemplary personal protection system 100 according to the present invention.

FIG. 1c is a front view of an exemplary personal protection system 100 according to the present invention, including an external equipment fastening arrangement.

FIG. 1d is a back view of another exemplary personal protection system 100 according to the present invention.

FIG. 2a illustrates an exemplary personal protection system 100 according to the present invention as worn by a user.

FIG. 2b illustrates an exemplary personal protection system 100 according to the present invention as worn by a user, in which the personal protection system 100 includes an external equipment fastening arrangement.

FIG. 2c is an exploded view of an exemplary personal protection system 100 according to the present invention as worn by a user, in which the personal protection system 100 includes an external equipment fastening arrangement.

FIG. 2d illustrates a variant of an exemplary personal protection system 100 according to the present invention.

FIGS. 3a through 3c are front, back, and side views, respectively, of an exemplary personal protection system 100 according to the present invention, in which a protective shroud is contained within a pouch.

FIGS. 4a through 4d illustrate an operational sequence for reconfiguring a system garment from a space-saving state to an unpackaged state.

FIGS. 5a through 5d illustrate an operational sequence for reconfiguring a system garment from an unpackaged state into a wearable state.

FIG. 6 illustrates an exemplary system garment according to the present invention.

FIGS. 7a through 7e illustrate an operational sequence for providing a user with system units of an exemplary system garment according to the present invention.

FIG. 8 illustrates an exemplary personal protection system including a transceiver arrangement for wirelessly transmitting and receiving information.

FIGS. 9a and 9b illustrate an exemplary switch according to the present invention for communicating information concerning the status of a zipper arrangement of the personal protection system.

FIG. 10 is a block diagram of an exemplary transceiver arrangement according to the present invention.

FIG. 11 illustrates an exemplary mask according to the present invention.

FIG. 12a is a block diagram showing functional blocks of the mask illustrated in FIG. 11.

FIG. 12b illustrates another exemplary mask according to the present invention.

FIGS. 13a through 13c are different views of an exemplary mask according to the present invention including a communications jack and a drinking supply jack.

FIG. 13d illustrates an exemplary communications jack according to the present invention.

FIG. 14 illustrates an exemplary mask according to the present invention including an adjustable light source.

FIGS. 15a and 15b illustrate another exemplary personal protection system according to the present invention.

FIGS. 16a and 16b illustrate another exemplary personal protection system according to the present invention.

FIGS. 17a through 17d illustrate an exemplary protective suit according to the present invention.

### DETAILED DESCRIPTION

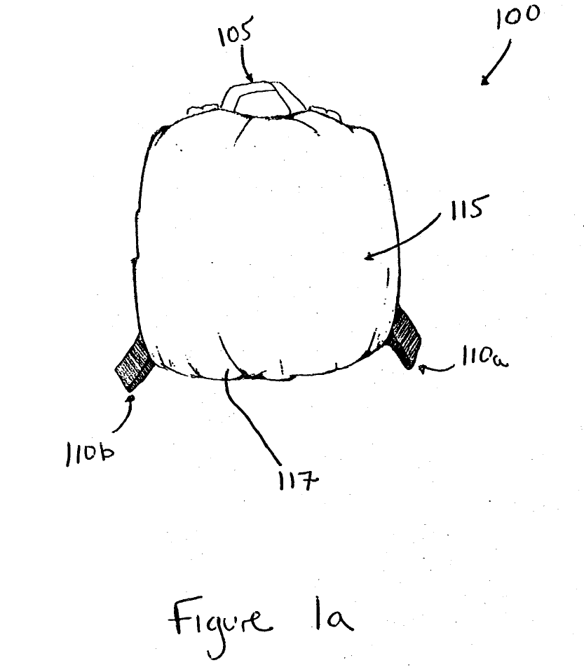

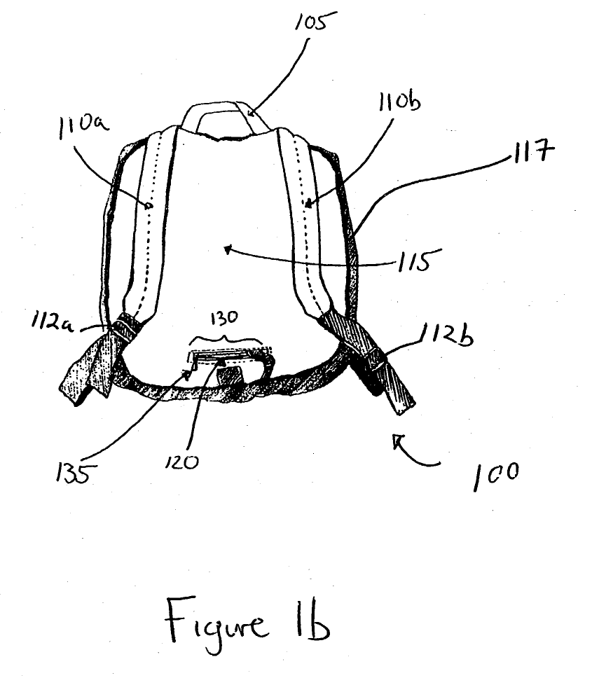

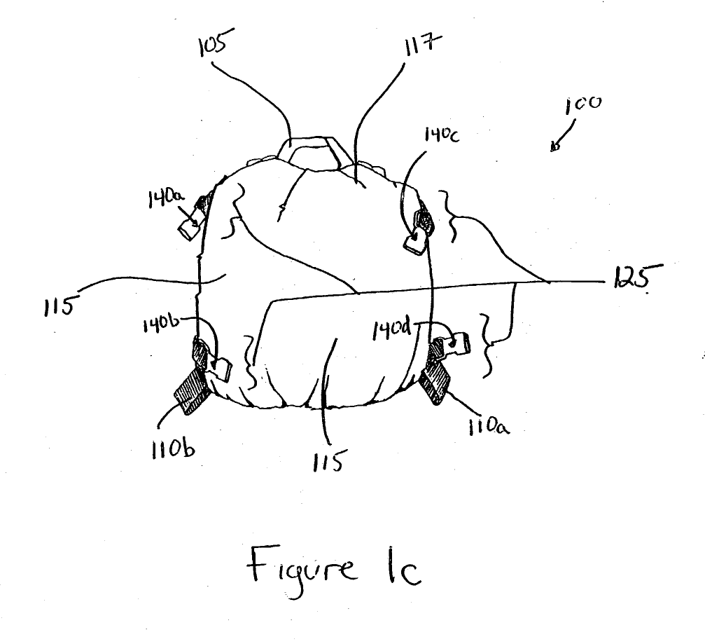

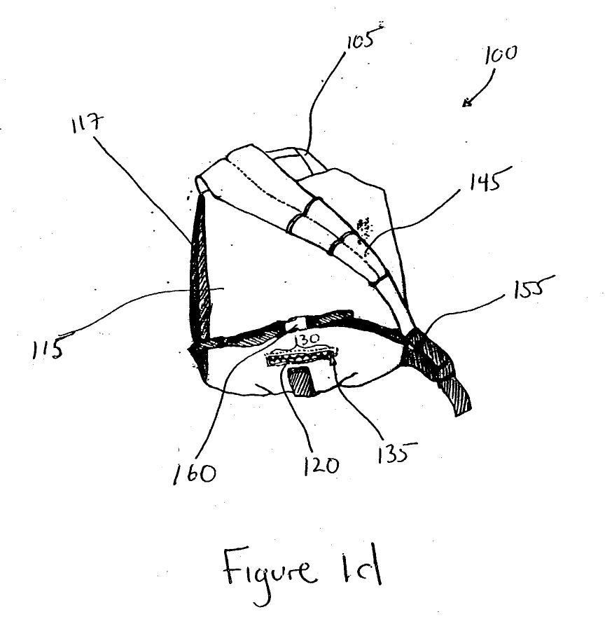

Referring to FIGS. 1a and 1b, there is seen a front and back view, respectively, of a first exemplary personal protection system 100 according to the present invention in a fully assembled state. Personal protection system 100 includes backpack 115 at least partially encased within a protective shroud 117, a carrying strap 105 coupled to the backpack 115 and/or the protective shroud 117, two harness straps 110a, 110b, including length adjustment buckles 112a, 112b, for coupling to a user (not shown), and a pouch 120 for containing the protective shroud 117 in a partially disassembled state of the personal protection system 100. The backpack 115 may contain, for example, a protection arrangement (not shown) for protecting the user from a biological, chemical, nuclear, and/or radiological hazard, such as, for example, a nuclear or biological attack.

The protective shroud 117 is operable to provide at least limited protection to the backpack 115 and its contents, while the personal protection system 100 is not being used or while the personal protection system 100 is being transported.

Additionally, the shroud 117 may be colored, for example, to indicate the type of hazard protection gear contained within the backpack 115 of the personal protection system 100. For example, a red colored shroud 117 may indicate that the backpack 115 contains hazard protection equipment for use in a nuclear hazard, and a green colored shroud 117 may indicate, for example, that the backpack 115 contains hazard protection equipment for use in a biological hazard. In addition to or in lieu of providing an identifying color, the protective shroud 117 may be provided with an identifying mark (not shown) to identify an institution, such as, for example, “FBI” for indicating the Federal Bureau of Investigation or “CDC” for indicating the Center for Disease Control. The identifying mark may also include cartoon depictions, for example, of Micky Mouse, to help facilitate use by children.

The protective shroud 117 may be constructed from any suitable material to achieve these features. Additionally, the protective shroud 117 may include fireproof and/or bulletproof materials, and may, for example, be fluorescently colored to help ensure that the personal protection system 100 may be seen under low light, foggy, and or smoky conditions.

As stated above, pouch 120 is configured to contain the protective shroud 117 in a partially disassembled state of the personal protection system 100. For this purpose, the shroud 117 may be, for example, rolled, folded, crimped, or crumpled before being placed in the pouch 120. In this manner, the protective shroud 117 may be conveniently hidden while a user (not shown) accesses the backpack 115 and its contents. Optionally, at least a portion of the protective shroud 117 may be either permanently or detachably coupled to the backpack 115. In this manner, it may be better ensured that the protective shroud 117 is not, for example, lost during transport or disassembly of the personal protection system 100.

To ensure that the protective shroud 117 remains adequately secured within the pouch 120, pouch 120 is provided with a fastening arrangement 130, by which the user (not shown) may gain access to the pouch 120. The exemplary embodiment illustrated in FIG. 1b shows fastening arrangement 130 provided with a zipper fastening arrangement 135. However, it should be appreciated that fastening arrangement 130 may include any arrangement operable to secure the protective shroud 117 within the pouch 120, such as, for example, velcro, buttons, snaps, hooks-and-loops, straps, etc.

Referring now to FIG. 1c, there is seen another exemplary embodiment of the present invention, in which the personal protection system 100 includes an external equipment fastening arrangement 125 configured to detachably couple to, for example, an external bag (not shown) for carrying additional items, such as a cell phone, beeper, tools, civilian equipment, etc. In this manner, a user may gain access to the external equipment while the personal protection system 100 is fully assembled.

For this purpose, the external equipment fastening arrangement 125 may, for example, be fixedly coupled to the backpack 115 or, alternatively, may, for example, be part of and fixedly coupled to the protective shroud 117.

The external equipment fastening arrangement 125 of the personal protection system 100 includes four buckles 140a, 140b, 140c, 140d, which are operable to detachably couple to respective buckle mates (not shown) of an external bag (not shown). However, it should be appreciated that external equipment fastening arrangement 125 may include any arrangement operable to detachably couple to, for example, the external bag (not shown), such as a plurality of buckles, velcro, buttons, snaps, hooks-and-loops, straps, any combination of these arrangements, etc.

Referring now to FIG. 1d, there is seen another exemplary personal protection system 100 according to the present invention in a fully assembled state, in which a single diagonally arranged harness strap 145, as well as a horizontal waist strap 150, are provided for coupling the personal protection system 100 to the user (not shown). Similar to the harness straps 110a, 10b of the exemplary embodiments discussed with reference to FIGS. 1a to 1c, the diagonally arranged harness strap 145 and the horizontal waist strap 150 may be adjusted in length to accommodate various sized users. For this purpose, the diagonally arranged harness strap 145 is provided with an adjustment buckle 155, and the horizontal waist strap 150 is provided with a waist buckle arrangement 160.

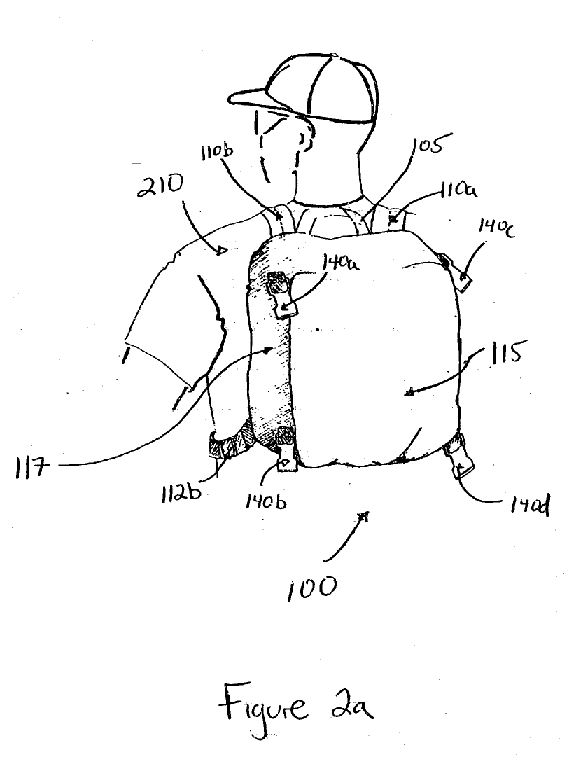

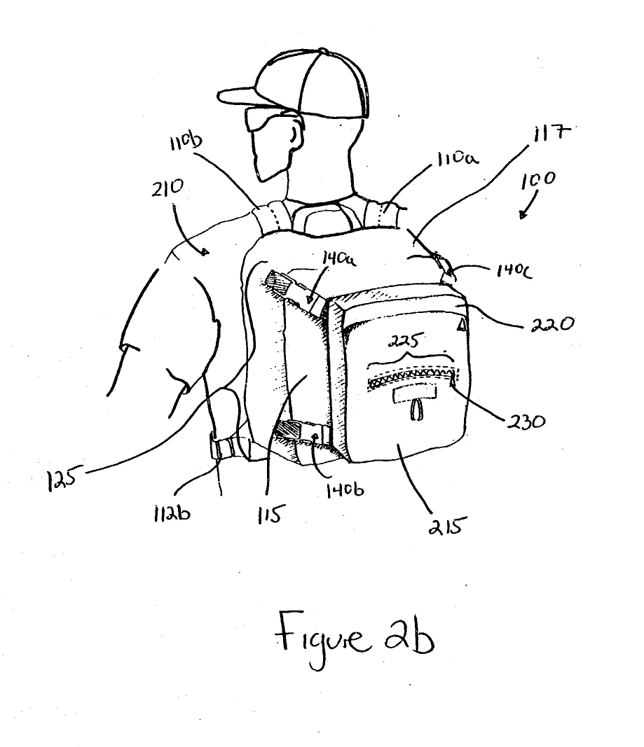

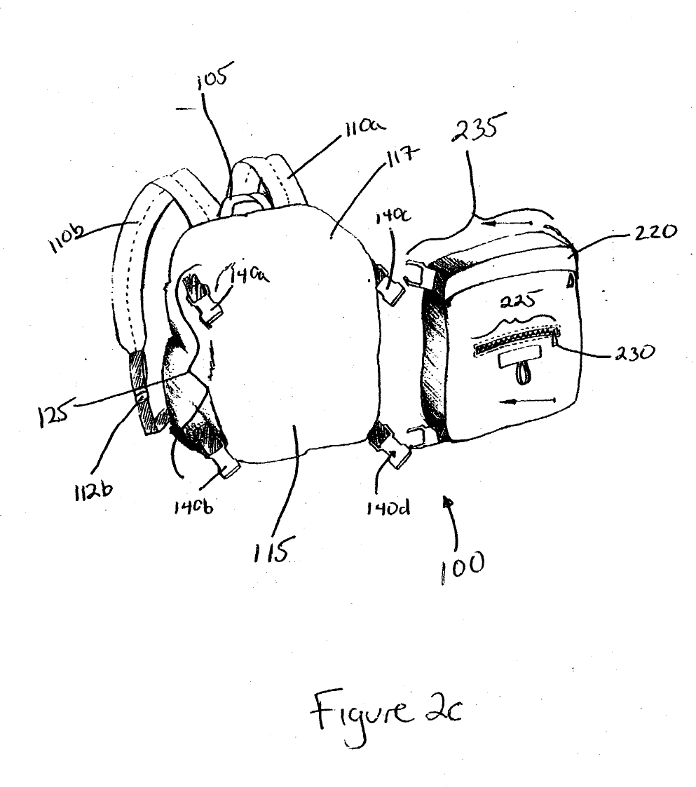

Referring now to FIG. 2a, there is seen another exemplary personal protection system 100 of FIGS. 1a and 1b as worn by a user 210. As shown in FIG. 2a, the personal protection system 100 is coupled to the user 210 via harness straps 110a, 110b, the lengths of which may be adjusted using respective length adjustment buckles 112a, 112b. In this manner, the personal protection system 100 may be adjusted to accommodate various sized users 210.

Referring now to FIG. 2b, there is seen the exemplary personal protection system 100 of FIG. 1c as worn by user 210. As shown in FIG. 2b, the personal protection system 100 includes the external equipment fastening arrangement 125 for detachably coupling to external equipment 215. External equipment 215 may include, for example, a bag 220 configured to contain additional items (not shown), as well as a bag fastening arrangement 225 for securing the additional items (not shown) within the bag 220. FIG. 2b shows bag fastening arrangement 225 as including a bag zipper arrangement 230. However, it should be appreciated that bag fastening arrangement 225 may include any arrangement operable to securely contain the additional items (not shown) within the bag 220, such as, for example, velcro, buttons, snaps, hooks-and-loops, straps, a pull string, any combination of these arrangements, etc.

The external equipment 215 may be detached from the personal protection system 100 either before or after the user 210 secures the protection system 100 to his/her person. In this manner, the user 210 may gain access to the additional items (not shown), which may be contained, for example, in the bag 220 of the external equipment 215.

Referring now to FIG. 2c, there is seen an exploded view of the second exemplary personal protection system 100 of FIG. 2b, in which the external equipment 215 is detached from the personal protection system 100. As shown in FIG. 2c, the external equipment 215 has an external equipment fastening arrangement 235 configured to detachably couple to the external equipment fastening arrangement 125 of the personal protection system 100. As shown in FIG. 2c, external equipment fastening arrangement 235 includes buckle mates 240a, 240b, 240c, 240d for detachably coupling to buckles 140a, 140b, 140c, 140d, respectively. Alternatively, however, it should be appreciated that the external equipment fastening arrangement 235 of the external equipment 215 may include any arrangement operable to detachably couple to the external equipment fastening arrangement 125 of the personal protection system 100, such as, for example, a plurality of buckles, velcro, buttons, snaps, hooks-and-loops, straps, a pull string, any combination of these, etc.

Referring to FIG. 2d, there is seen another exemplary personal protection system 100 according to the present invention, having second variant external equipment fastening arrangements 125, 235. As shown in FIG. 2d, the external equipment fastening arrangement 125 of the personal protection system 100 includes two buckles 140a, 140c, and the external equipment fastening arrangement 235 of the external equipment 215 includes two buckle mates 240a, 240c for detachably coupling to buckles 140a, 140c, respectively. However, in lieu of buckles 140b, 140d and buckle mates 240b, 240d, as shown in FIG. 2c, the external equipment fastening arrangements 125, 235 of FIG. 2d include a zipper fastening arrangement 250. In conjunction with the two buckle mates 240a, 240c for detachably coupling to buckles 140a, 140c, respectively, the zipper fastening arrangement 250 is operable to detachably couple the external equipment 215 to an exemplary personal protection system 100.

Although FIG. 2d shows a zipper fastening arrangement 250 operable to detachably couple the external equipment 215 to an exemplary personal protection system 100, it should be appreciated that any other arrangement operable to detachably couple the external equipment 215 to the personal protection system 100 may be employed, such as, for example, buttons, snaps, velcro, any combination of these arrangements, etc. Furthermore, it should be appreciated that the external equipment 215 may be fixedly coupled to the personal protection system 100 in at least one area. For example, in lieu of zipper fastening arrangement 250, a stitch may be provided to permanently secure the bottom side of the external equipment 215 to the personal protection system 100.

Either before or after the user secures the personal protection system 100 to his/her person, the user 210 may, for example, remove the protective shroud 117 from the backpack 115 to gain access to the backpack 115 and its contents. For this purpose, the user may, for example, roll, fold, crimp, or crumple the protective shroud 117 and store the shroud 117 in the pouch 120 of the backpack 115 via shroud fastening arrangement 130. In this manner, the protective shroud 117 may be conveniently hidden while the user gains access to the backpack 115 and its contents. Optionally, at least a portion of the protective shroud may be either permanently or detachably coupled to the backpack. In this manner, it may be better ensured that the protective shroud 117 is not, for example, lost during transport or disassembly of the personal protection system 100.

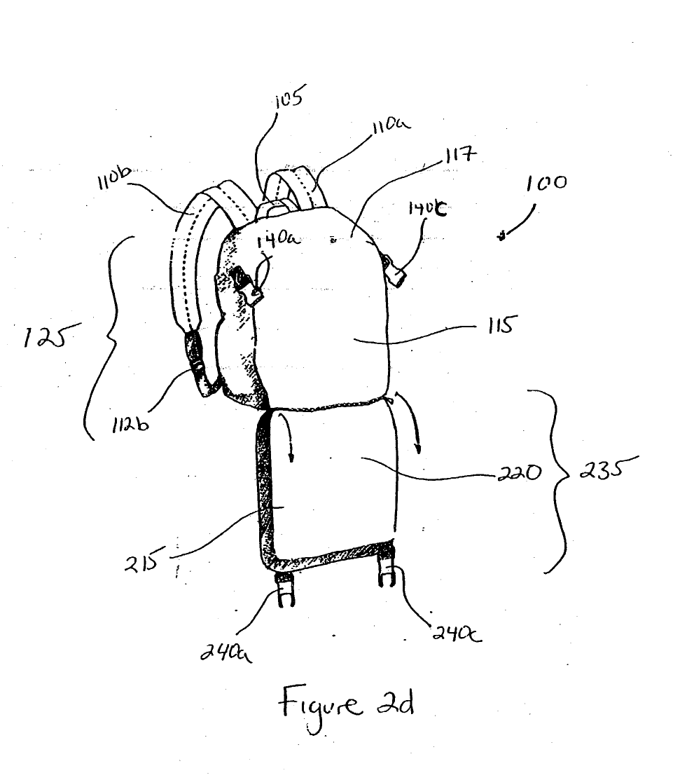

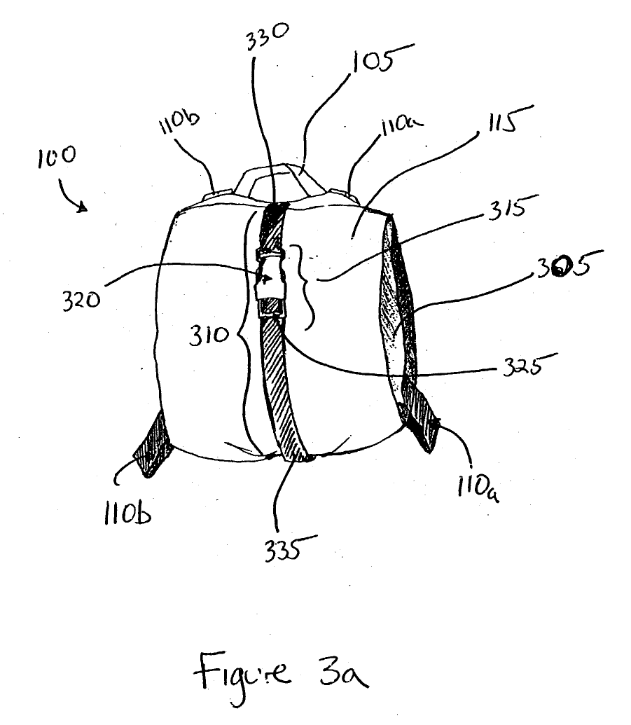

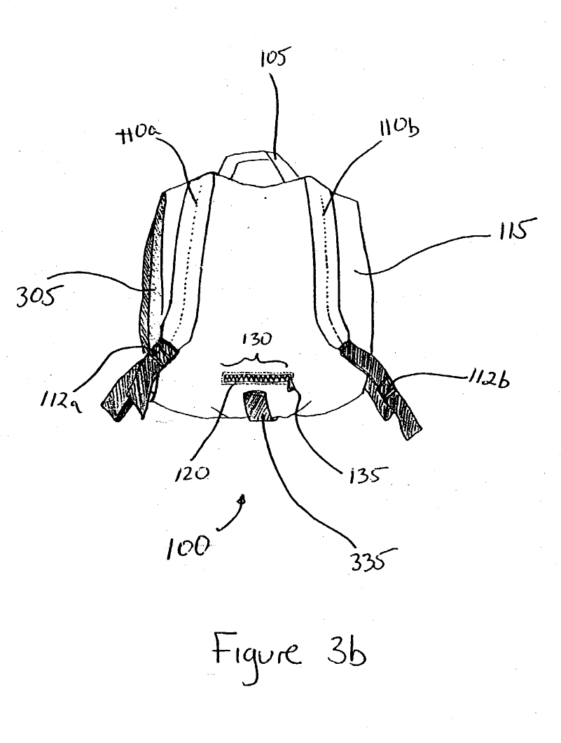

Referring now to FIGS. 3a through 3c, there is seen a front view, a back view, and a side view, respectively, of an exemplary personal protection system 100 according to the present invention in a partially disassembled state. Specifically, FIGS. 3a through 3c show the exemplary personal protection system 100 with the protective shroud (not shown in FIGS. 3a through 3c) secured within the pouch 120 of the backpack 115. With the protective shroud 117 removed, it may be seen that backpack 115 includes a system garment 305 secured in a space-saving manner by garment fastening arrangement 310.

In the exemplary embodiments discussed below, the system garment 305 is fixedly attached to the backpack 115 in at least one area, thereby forming a single functional unit. However, it should be appreciated that the backpack 115 may be comprised entirely of the system garment 305. In this manner, the harness straps 110a, 110b are attached directly to the system garment 305, as well as an arrangement for coupling the harness straps 110a, 110b to the system garment 305. For example, the backpack 115 may, for example, consist only of harness straps 110a, 110b and a connection plate (not shown) for fixedly (or detachably) coupling the harness straps 110a, 110b to the system garment 305.

System garment 305 includes at least one article of clothing, for example, a vest, jacket, overcoat, etc., operable to be worn by the user 210 for protecting the user 210, for example, from a nuclear, biological, chemical, or radiological hazard.

For this purpose, the system garment includes a plurality of system units, which may be employed by the user 210 for protection. These units may include, for example, a gas mask, an escape mask, a protective suit, etc.

The garment fastening arrangement 310 is operable to secure the system garment 305 in a space-saving manner. As illustrated in FIGS. 3a through 3c, garment fastening arrangement 310 includes a garment buckle fastening arrangement 315 having a first strap member 335 fixedly secured to the system garment 305 at one end and fixedly secured to a garment buckle 320 at the other end. Buckle fastening arrangement 315 also includes a second strap member fixedly secured to the system garment 305 at one end and fixedly secured to a garment buckle mate 325 at the other end, the garment buckle mate 325 being operable to detachably couple to the garment buckle 320.

Although FIGS. 3a through 3c show garment fastening arrangement 310 including a garment buckle fastening arrangement 315, it should be appreciated that garment fastening arrangement 310 may include any arrangement operable to secure the system garment 305 in a space-saving manner, such as, for example, straps, belts, velcro, zippers, snaps, buttons, hooks-and-loops, a pull string, any combination of these arrangements, etc.

As shown in FIG. 3c, the system garment 305 may be stored in a space-saving manner, for example, by being rolled into a spiral configuration. However, it should be appreciated that the system garment 305 may be stored in other manners, such as, for example, by folding, crimping, crumpling, etc.

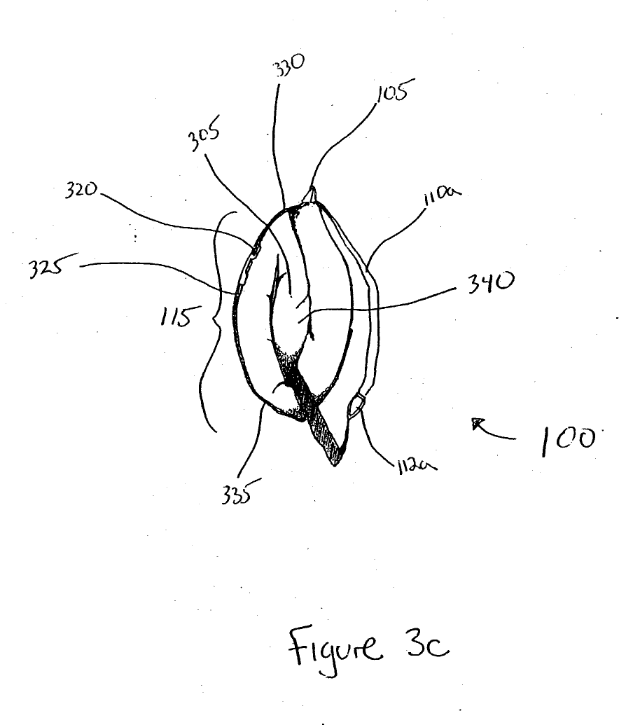

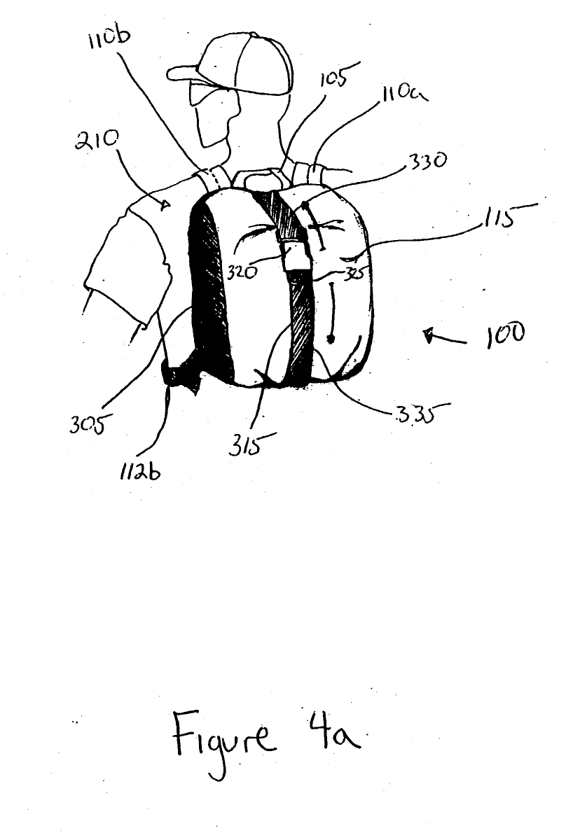

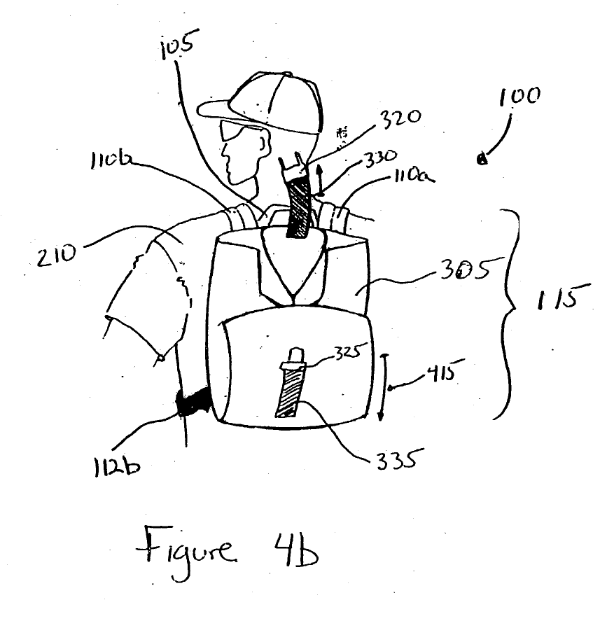

Referring now to FIGS. 4a through 4d, there is seen an operational sequence for reconfiguring the system garment 305 from the space-saving state into an unpackaged state.

Initially, as shown in FIG. 4a, the user 210 wears the exemplary personal protection system 100, the protective shroud (not shown) being secured within the pouch 120 of the backpack 115.

Next, the user 210 disengages the garment fastening arrangement 310 to gain access to the system garment 305. For an exemplary personal protection system 100 having a garment buckle fastening arrangement 315, this may be accomplished, for example, by detaching the garment buckle 320 from the garment buckle mate 325, as shown in FIG. 4b. For this purpose, the user 210 may, for example, reach behind his/her person to manually disengage the garment fastening arrangement 310, ask a second person (not shown) to disengage the garment fastening arrangement 310, or may temporarily remove the personal protection system 100 to disengage the garment fastening arrangement 310.

Once the garment fastening arrangement 310 has been disengaged, the system garment 305 may be reconfigured from the space-saving state into the unpackaged state. If, for example, the system garment 305 was secured in a space-saving manner by being rolled, the system garment 305 may be reconfigured, for example, by unrolling, in the direction of arrow 415, and unfolding, in the direction of arrows 420a, 420b, into the unpackaged state, as shown in FIGS. 4b through 4d. For this purpose, the user 210 may, for example, reach behind his person to manually unroll and unfold the system garment 305, may ask a second person (not shown) to unroll and unfold the system garment 305, or may temporarily remove the personal protection system 100 to unroll and unfold the system garment 305.

Once the system garment 305 has been reconfigured into the unpackaged state, the system garment 305 may then be reconfigured once more into a wearable state.

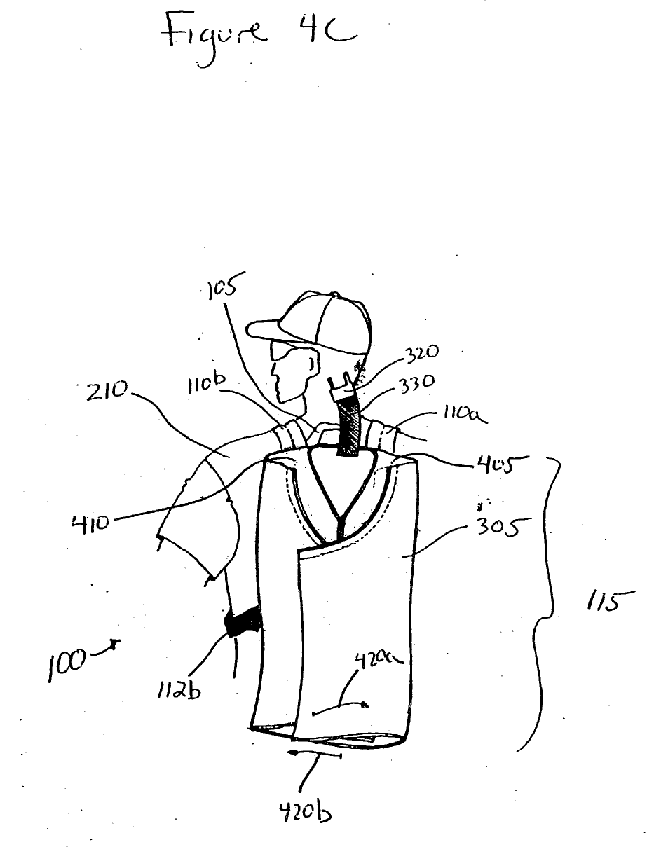

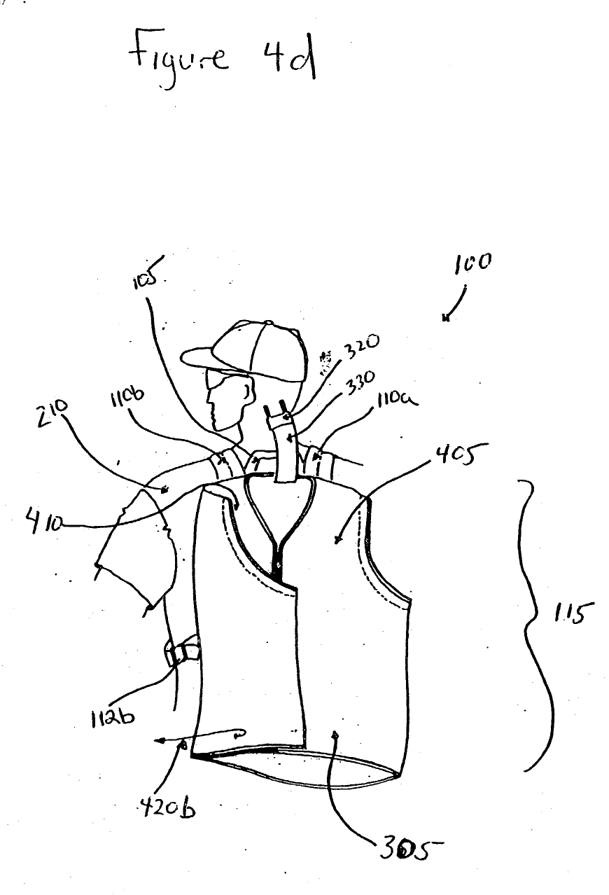

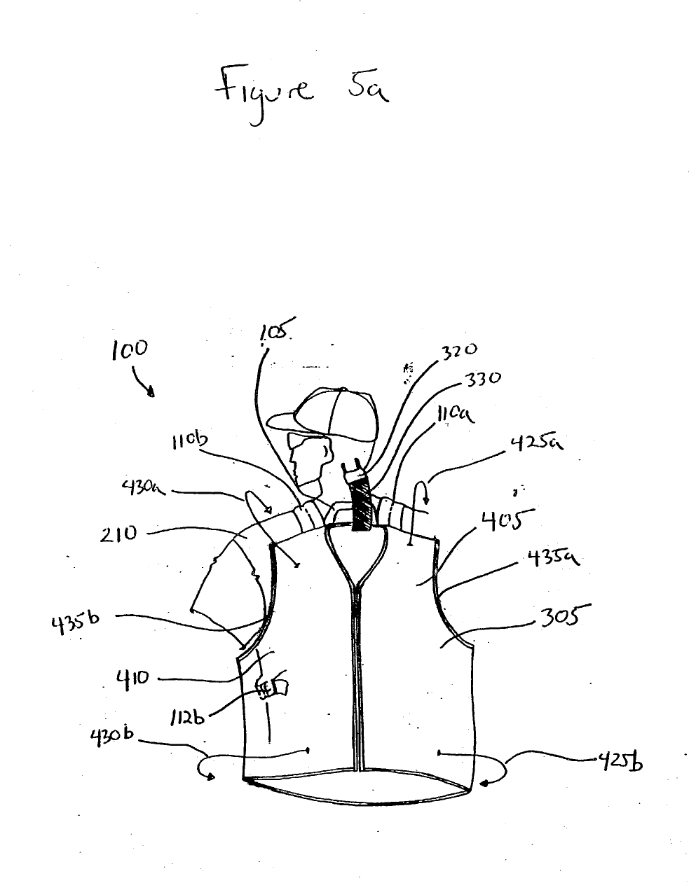

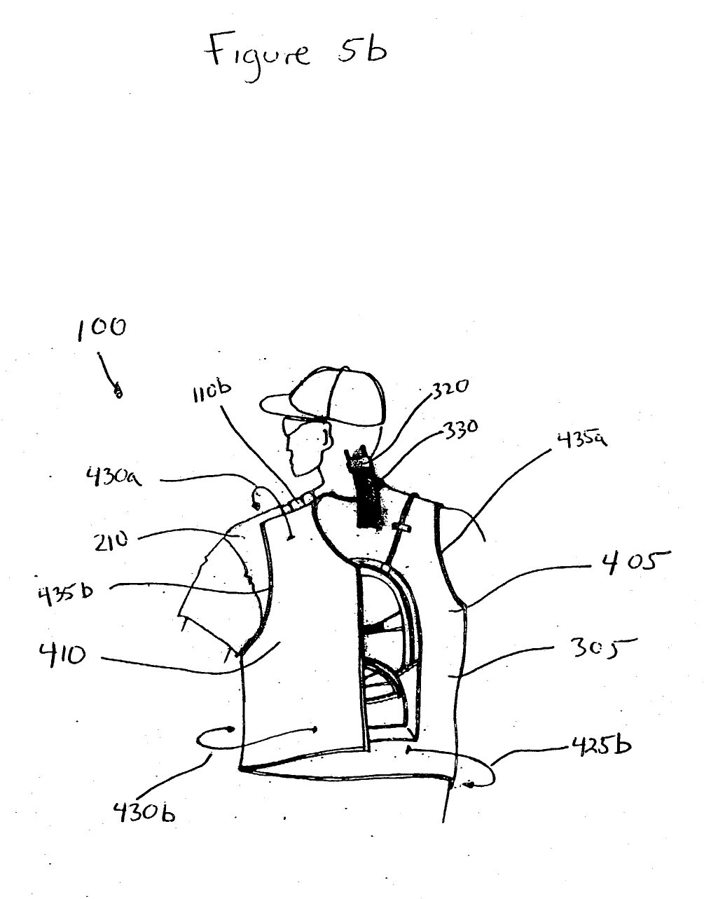

Referring now to FIGS. 5a through 5d, there is seen an operational sequence for reconfiguring the system garment 305 from the unpackaged state into the wearable state. Initially, as shown in FIGS. 5a and 5b, the user 210 folds over right front segment 405 of the system garment 305 by folding the segment 405 in front of his/her person in the direction of arrows 425a, 425b. Then, as shown in FIGS. 5b and 5c, the user folds over left front segment 410 by folding the segment 410 in front of his/her person in the direction of arrows 430a, 430b. Once both segments 405, 410 have been folded in front of the user 210, the user extends his/her arms through arm slots 435a, 435b, as shown in FIGS. 5b and 5c.

Once the user has extended his/her arms through the arm slots 435a, 435b, the user may, for example, fasten the system garment 305 to his/her person using garment securing arrangement 440, as shown in FIG. 5d. It should be noted that, although FIG. 5d illustrates garment securing arrangement 440 as a zipper fastening arrangement, any alternative arrangement operable to secure the system garment 305 to the user 210 may be used, such as, for example, straps, belts, velcro, zippers, snaps, buttons, hooks-and-loops, any combination of these arrangements, etc.

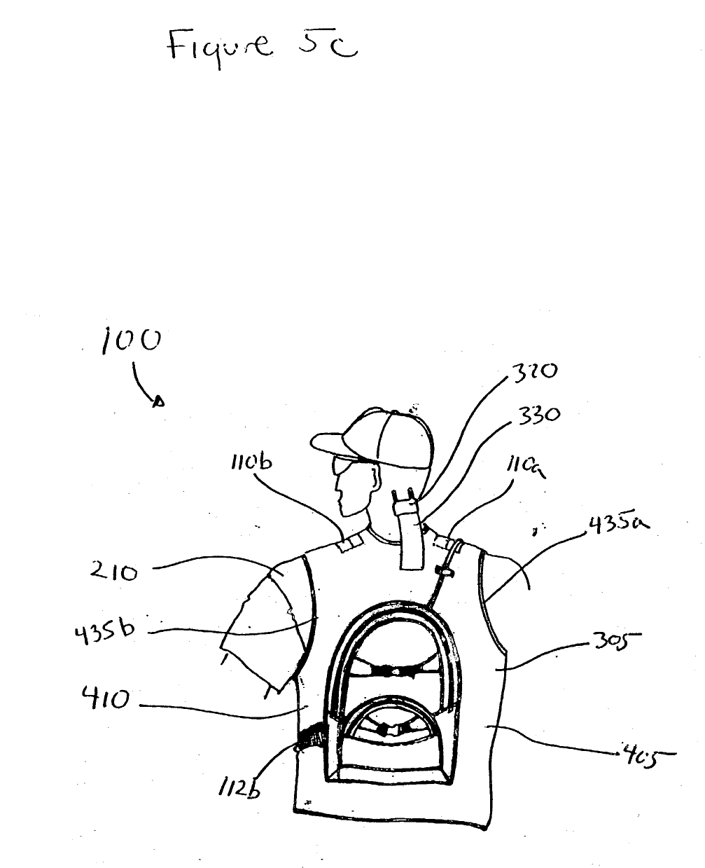

Referring now to FIG. 6, there is seen another exemplary system garment 305 including adjustable straps 605a, 605b, 605c, . . . , 605g for fitting the system garment 305 to the user 210. In this manner, adjustable straps 605a, 605b, 605c, . . . , 605g may be varied in length, so that the system garment 305 may accommodate various sized users 210. It should be noted that, although FIG. 6 shows seven adjustable straps 605a, 605b, 605c, . . . , 605g, any number of adjustable straps may be used or, alternatively, any other adjusting arrangement may be employed, such as, for example, straps, belts, velcro, zippers, snaps, buttons, hooks-and-loops, any combination of these arrangements, etc.

The system garment 305 includes a plurality of system units 600a, 600b, 600c, . . . , 600n for protecting the user 210 from, for example, a biological, chemical, nuclear, and/or radiological hazard. Each of the system units 600a, 600b, 600c, . . . , 600n includes at least one respective piece of hazard equipment 615a, 615b, 615c, . . . , 615n detachably secured to the system garment 305 via respective equipment securing arrangement 610a, 610b, 610c, . . . , 610n.

The system units 600a, 600b, 600c, . . . , 600n may include, for example, hazard equipment operable to at least assist in protecting the user 210 from a hazardous condition, for example, a biological hazard, a chemical hazard, a radiological hazard, and/or a nuclear hazard. Such equipment may include, for example, at least one Nuclear-Biological-Chemical-Radiological (NBCR) escape mask, at least one smoke escape mask, at least one nuclear gas mask, at least one gas mask filter, at least one protective suit, at least one set of protective gloves, at least one pair of protective booties, a roll of tape, a flashlight, radiation blocking pills (e.g., potassium iodide), at least one gas detection device, at least one radiation detection device (e.g., a Geiger counter), a water purifier, a first-aid kit, a two-way radio device, a cell phone, a rescue whistle, at least one light-stick, a compass, an AM/FM radio, a safety horn, at least one writing utensil, waterproof matches, a utility belt, a parachute, and/or a portable drinking supply (e.g., “Camel-Bak” drinking supply produced by Camel Bak corporation, Petaluma, Calif.).

Referring to FIGS. 5d and 6, there is seen the exemplary system garment 305 including seven system units 600a, 600b, 600c, . . . , 600g for protecting the user 210 from, for example, a biological, chemical, nuclear, and/or radiological hazard. Each of the seven system units 600a, 600b, 600c, . . . , 600g includes a respective piece of hazard equipment 615a, 615b, 615c, . . . , 615g detachably secured to the system garment 305 via seven respective equipment securing arrangements 610a, 610b, 610c, . . . , 610g.

As shown in FIG. 6, the respective equipment securing arrangements 610a, 610b, 610c, . . ., 610g of the respective system units 600a, 600b, 600c, . . . , 600g include pockets 610a, 610b, 610c, 610e, and 610g (with associated securing arrangements, e.g., buttons, zippers, flaps, etc.), as well as flap securing arrangements 610d and 610f, flaps, straps, etc. However, it should be appreciated that the system units 600a, 600b, 600c, . . . , 600g may include one or more of various types of securing arrangements 610a, 610b, 610c, . . . , 610g, which may include, for example, pockets, flaps, straps, velcro attaching arrangements, buttons, etc.

In this manner, the system garment 305 may include, for example, all pocket-type securing arrangements 610a, 610b, 610c, . . . , 610g, all flap-type securing arrangements 610a, 610b, 610c, . . . , 610g, any combination of different type securing arrangements 610a, 610b, 610c, . . . , 610n, etc.

It should also be appreciated that there may exist any number of system units 600a, 600b, 600c, . . . , 600n arranged on the system garment 305 in any one of various alternative configurations. For example, the system garment 305 may include ten system units arranged on one or both of the right and left front segments 405, 410 of the system garment 305. Or, for example, the system garment 305 may include 20 system units, distributed evenly or unevenly across the system garment. Or, for example, at least one of the system units 600a, 600b, 600c, . . . , 600n may be arranged on the sides or the back of the system garment 305.

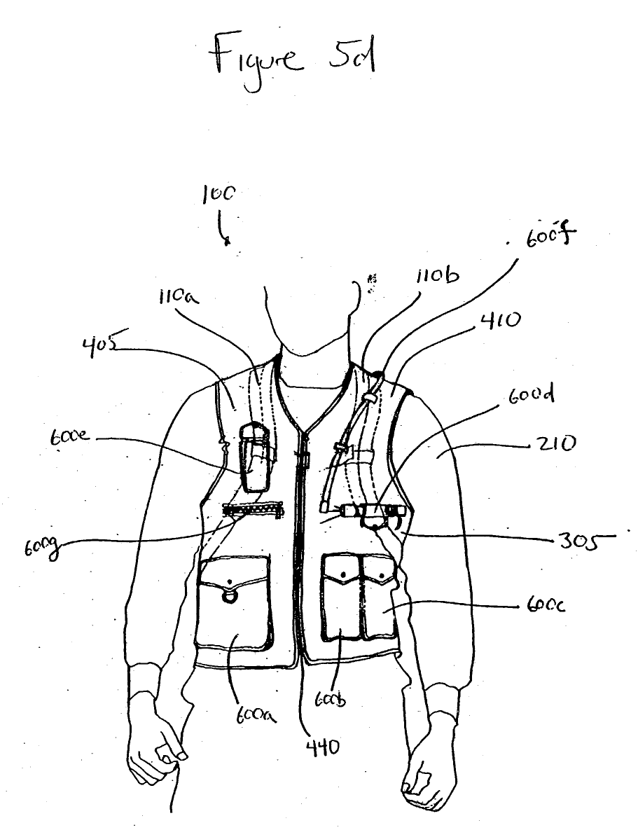

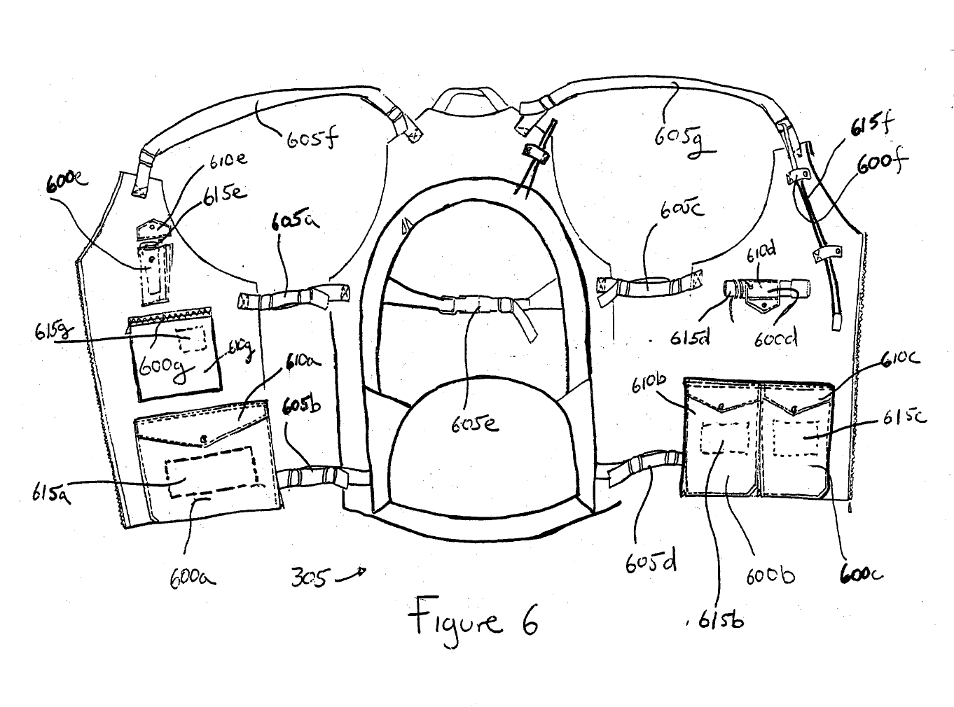

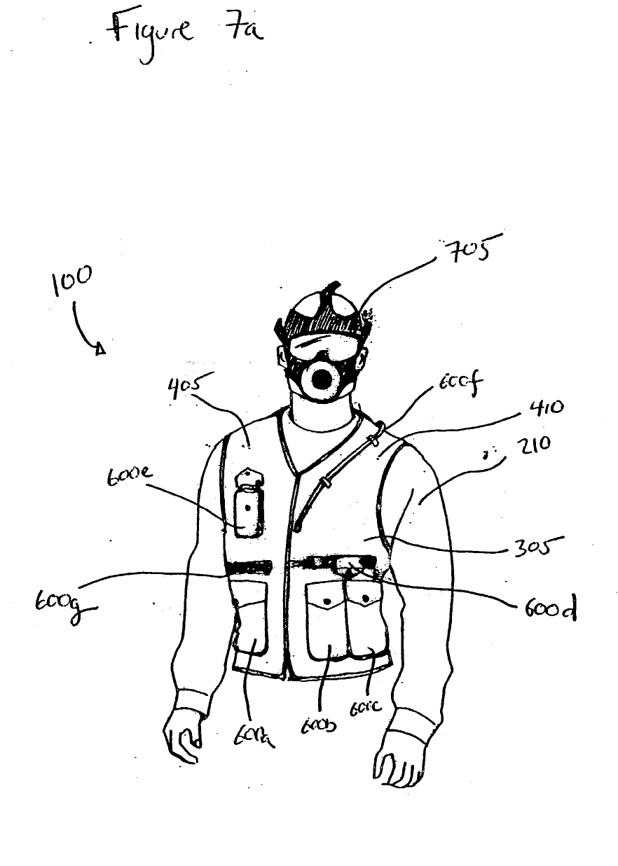

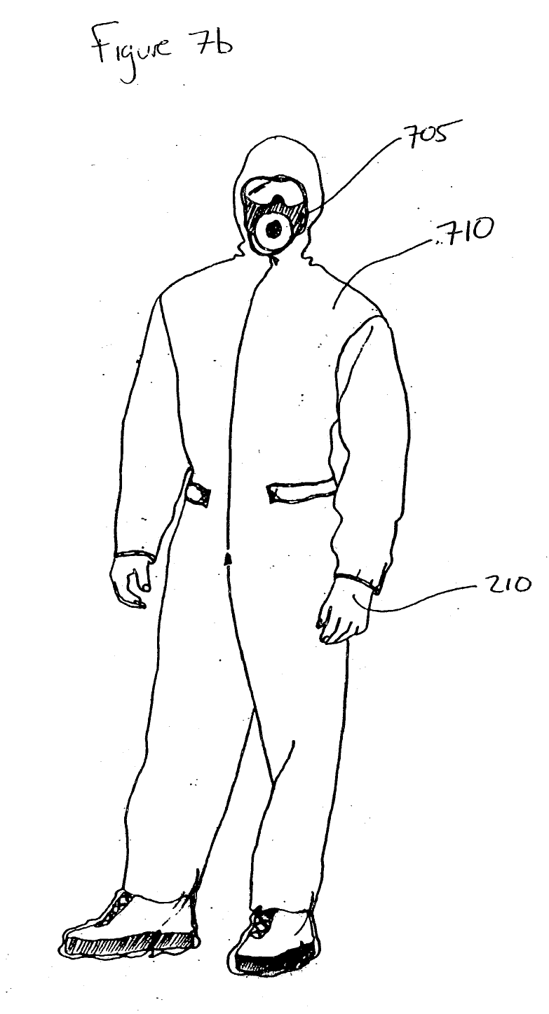

Referring now to FIGS. 7a through 7e, there is seen an exemplary operational sequence for supplying the user 210 with at least some of the system units 600a, 600b, 600c, . . . , 600n to, for example, to protect the user 210 from a biological, chemical, nuclear, and/or radiological hazard.

In accordance with the above sequence, the user 210 first removes a gas mask 705 and a utility belt 730 from the plurality of system units 600a, 600b, 600c, . . . , 600n. Once removed, the user may fit the mask 705 to his face, as shown in FIG. 7a. Then, the user 210 removes a protective suit 710 from the system units 600a, 600b, 600c, . . . , 600n. Once removed, the user fits the suit 710 to his/her person, as shown in FIG. 7b. Then, the user 210 removes gloves 715, protective booties 720, and adhesive tape 725 from the system units 600a, 600b, 600c, . . . , 600n. Once removed, the user 210 fits the gloves 715 and the booties 720 to his/her person, and then tapes the gloves 715 and the booties 720 in a sealing manner with adhesive tape 725, as shown in FIGS. 7c and 7d. Next, the user fits the utility belt 730 to his/her person over the protective suit 710, as shown in FIG. 7e. The utility belt may include, for example, a portable drinking supply 735.

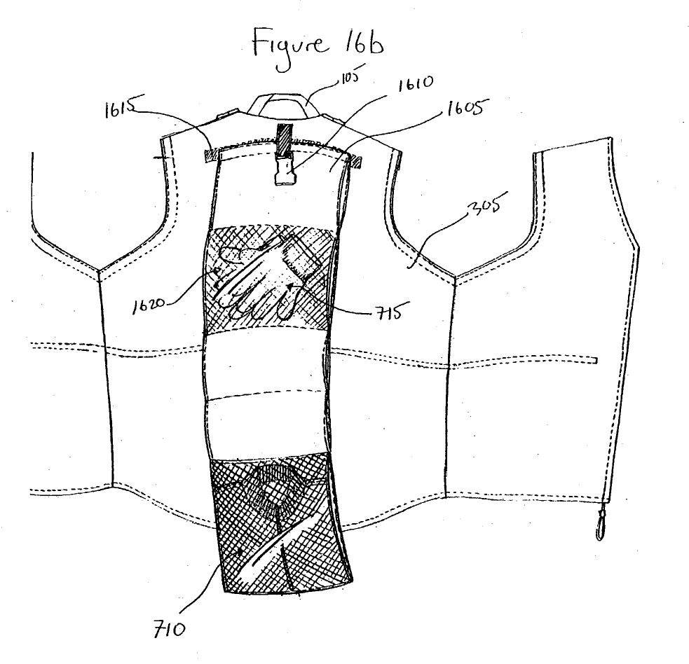

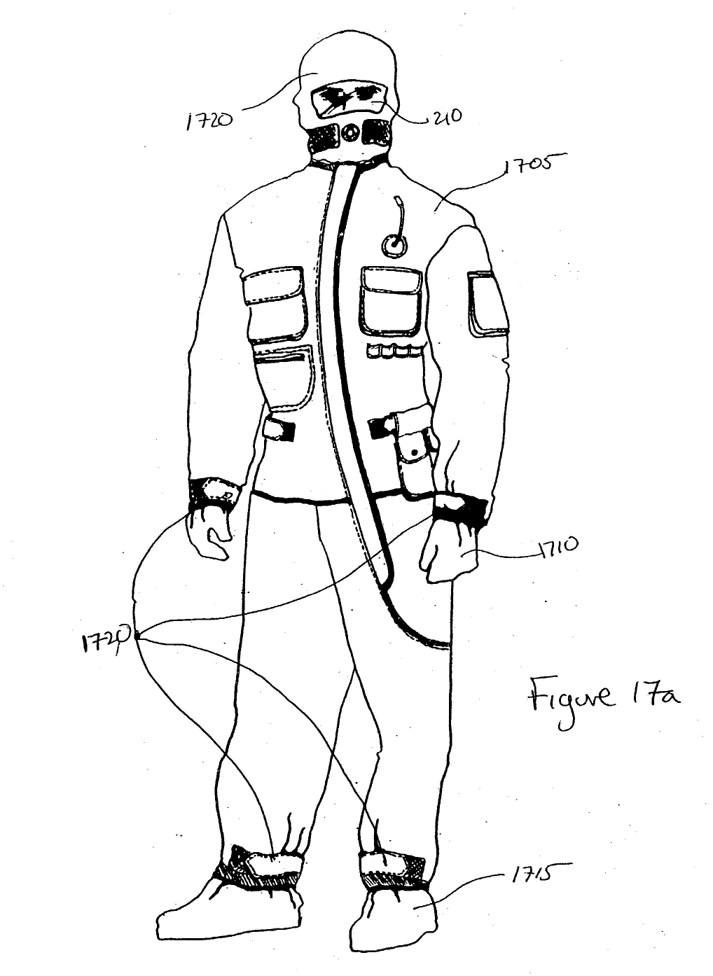

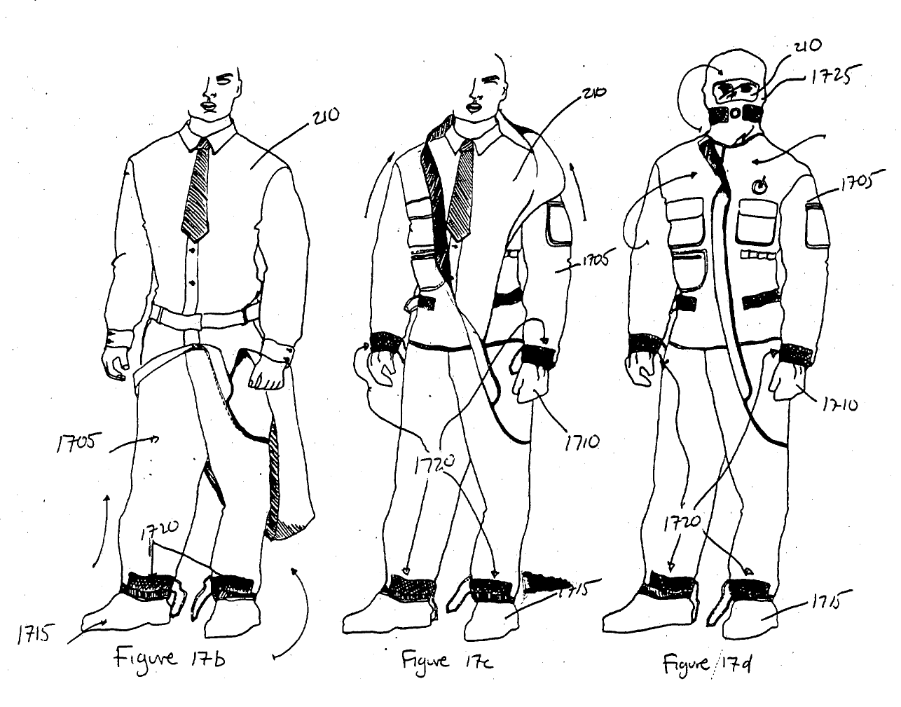

Referring now to FIG. 17a, there is seen an exemplary protective suit 1705 according to the present invention. Protective suit 1705 includes attached gloves 1710, attached booties 1715, and an attached gas mask 1720.

Referring now to FIGS. 17b through 17d, there is seen an operational sequence for configuring the suit 1705 into a wearable state by the user 210. First, as shown in FIG. 17b, the user 210 slides his/her feet through the suit 1705 and into the booties 1715. Then, as shown in FIG. 17c, the user 210 slides his arms through the suit and into the gloves 1710. Finally, the user 210 places the attached mask 1725 over his/her face and fastens the suit 1705, as shown in FIG. 17d. Once the suit 1705 is secured to the user 210, as shown in FIG. 17d, the user 210 may adjust the fit of the booties 1715 and gloves 1710 by using adjusting straps 1720, which may, for example, include velcro straps.

It should be appreciated that the mask 1720 may be partially or fully attached to the suit 1705. Furthermore, the suit 1705 may also include at least one pocket (not shown) for carrying one or more of the system units 600a, 600b, 600c, . . . , 600n.

The operational sequence illustrated in FIGS. 7a through 7e permits sensitive equipment to be covered (i.e., protected) by the protective suit 710, while simultaneously providing access to necessary equipment via the utility belt 730. This may be necessary, for example, if the user 210 is required to perform a task within a hazard zone, such as, for example, a nuclear hazard zone, a chemical hazard zone, a biological hazard zone, and/or a radiological hazard zone.

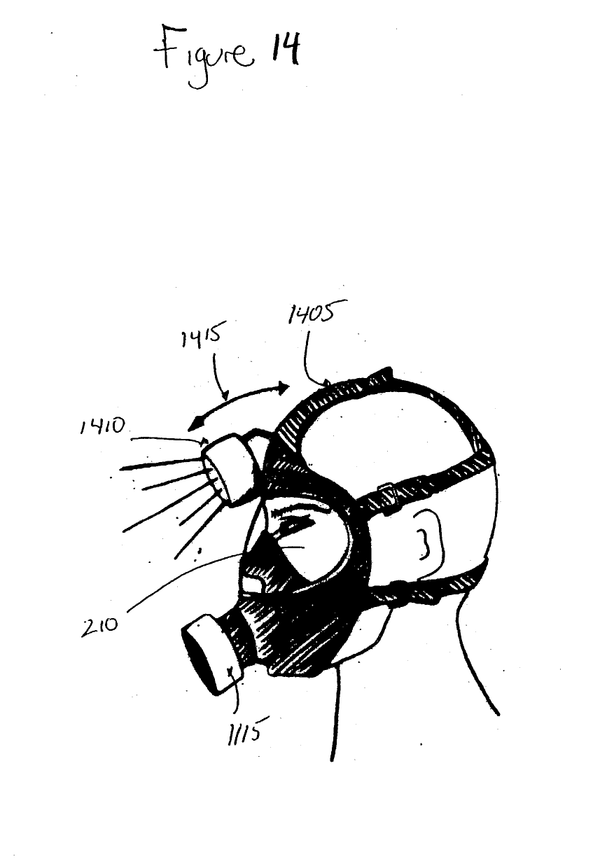

Referring now to FIG. 15a, there is seen another exemplary personal protection system 100 according to the present invention, which includes the protective suit 710. As seen in FIG. 15a, garment fastening arrangement 310 is shown detached to permit the user to gain access to the folded system garment 305, in similar fashion to the exemplary embodiments discussed above. However, this exemplary embodiment shows the protective suit 710 secured to the system garment 305 in a space-saving manner via suit fastening arrangement 1510.

Similar to the garment fastening arrangement 310, the user 210 may, for example, reach behind his/her person to manually disengage the suit fastening arrangement 1510, ask a second person (not shown) to disengage the suit fastening arrangement 1510, or may temporarily remove the personal protection system 100 to disengage the suit fastening arrangement 1510.

After disengaging the suit fastening arrangement 1510, the protective suit 710 may be reconfigured from the space-saving state into an unpackaged state, as shown in FIG. 15b. If, for example, the protective suit 710 was secured in a space-saving manner by being rolled, the protective suit 710 may be reconfigured, for example, by unrolling, in the direction of arrow 1515 into the unpackaged state. For this purpose, the user 210 may, for example, reach behind his person to manually unroll and unfold the protective suit 710, may ask a second person (not shown) to unroll and unfold the protective suit 710, or may temporarily remove the personal protection system 100 to unroll and unfold the protective suit 710.

Once the protective suit 710 has been reconfigured into the unpackaged state, the protective suit 710 may then be reconfigured once more into a wearable state. For this purpose, the user 210 proceeds through steps similar to those for reconfiguring the system garment 305 from the unpackaged state to the wearable state, as shown in FIGS. 5a through 5d.

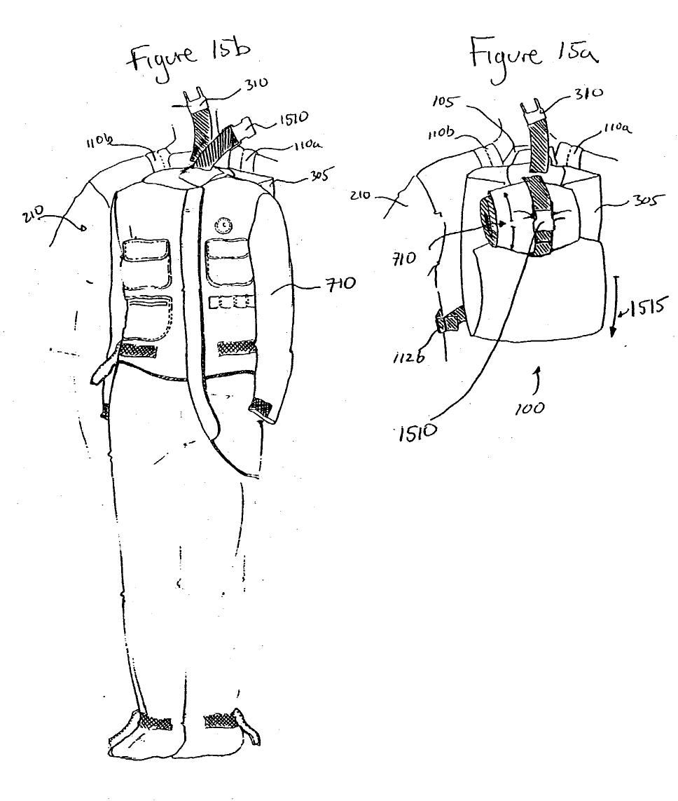

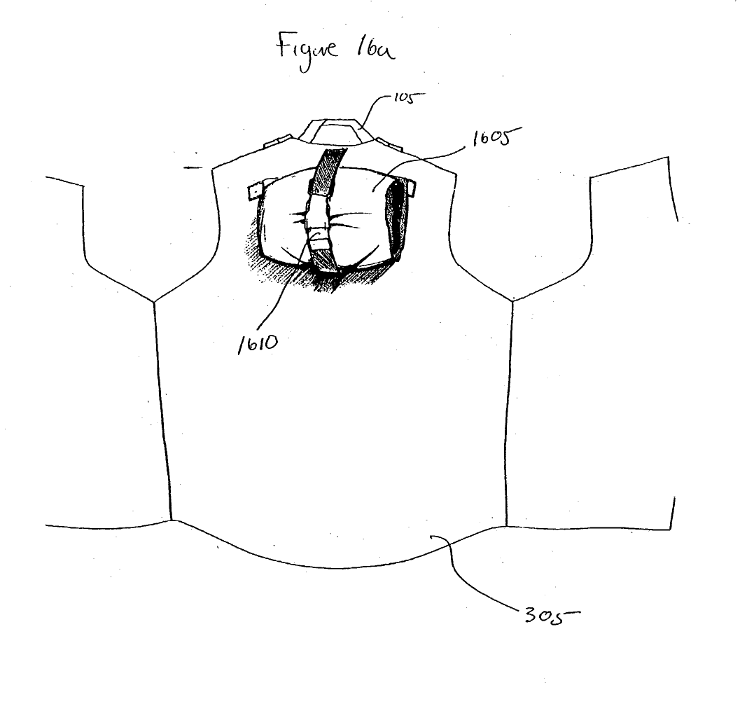

In accordance with a variant of the exemplary personal protection system illustrated in FIGS. 15a and 15b, a system unit bag 1605 is provided in lieu of the protective suit 710, as shown in FIGS. 16a and 16b. In this manner, the unit bag 1605 is secured to the system garment 305 in a space-savings manner via bag fastening arrangement 1610.

Similar to the garment fastening arrangement 310, the user 210 may, for example, reach behind his/her person to manually disengage the bag fastening arrangement 1610, ask a second person (not shown) to disengage the bag fastening arrangement 1610, or may temporarily remove the personal protection system 100 to disengage the bag fastening arrangement 1610.

After disengaging the bag fastening arrangement 1610, the system unit bag 1605 may be reconfigured from the space-saving state into an unpackaged state, as shown in FIG. 16b. If, for example, the system unit bag 1605 was secured in a space-saving manner by being rolled, the system unit bag 1605 may be reconfigured, for example, by unrolling into the unpackaged state. For this purpose, the user 210 may, for example, reach behind his person to manually unroll and unfold the system unit bag 1605, may ask a second person (not shown) to unroll and unfold the system unit bag 1605, or may temporarily remove the personal protection system 100 to unroll and unfold the system unit bag 1605.

The system bag 1605 is configured to carry at least one of the system units 600a, 600b, 600c, . . . 600n, such as, for example, the protective suit 710 and gloves 715. For this purpose, the system bag 1605 may be provided with at least one compartment 1620 to carry, for example, the protective suit 710 and gloves 715. The at least one compartment 1620 may, for example, be vacuum sealed to permit the system units 600a, 600b, 600c, . . . 600n to be stored in a space-savings manner while the personal protection system 100 is not in use. Furthermore, the system bag 1605 may optionally be either permanently or detachably secured to the system garment 305 by bag contact arrangement 1615, which may include, for example, pockets, flaps, straps, velcro attaching arrangements, buttons, etc.

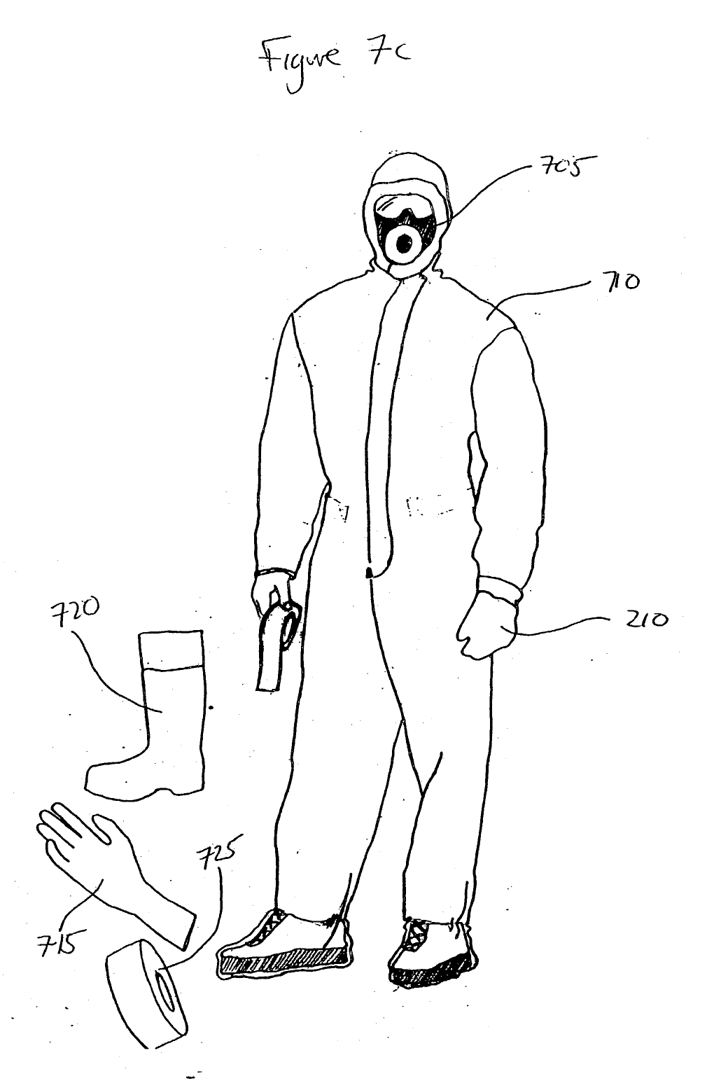

Referring now to FIG. 8, there is seen another exemplary personal protection system 100 according to the present invention, including a transceiver arrangement 805 operable to wirelessly receive and transmit information from at least one remote location (not shown).

The transceiver arrangement 805 is configured to wirelessly transmit status information of the user 210 to at least one remote location. In this manner, the user 210 may, for example, communicate vital information to the remote location, for example, a remote command station, within a nuclear hazard zone, a chemical hazard zone, a biological hazard zone, and/or a radiological hazard zone. The information transmitted may include, for example, the geographical location of the user 210, life signs of the user 210 (e.g., heart rate, breathing rate, etc.), hazard level (e.g., how dangerous is the hazard condition), emergency information, etc.

The transceiver arrangement 805 may also be configured to transmit information concerning the status of the personal protection system, such as, for example, whether the personal protection system 100 is in the fully assembled state, whether the personal protection system 100 is in the partially disassembled stated, whether the personal protection system 100 is in the wearable state, etc. In this manner, the personal protection system 100 may communicate a progress sequence of preparing the personal protection system for use, thereby permitting one or more observers located at the remote location, for example, the command station, to monitor the progress and/or status of one or more users 210 in the hazard zone. By monitoring the progress of the users 210, the observers may obtain vital information concerning the readiness of various users 210 which, in turn, may permit the observers to properly allocate resources and manpower to effectively and efficiently deal with the hazard.

The transceiver arrangement 805 may be activated manually by the user 210 for transmission of the data or, alternatively, the transceiver arrangement 805 may be activated automatically upon the occurrence of a particular event associated with the personal protection system 100. For example, the transceiver arrangement 805 may automatically transmit information when the user 210 removes the protective shroud 117 and/or disengages the garment buckle 320. In this manner, the personal protection system 100 can alert the remote station that the user 210 is in the process of preparing the personal protection system 100 for a hazard condition, without need for the user 210 to perform the additional step of manually initiating a transmission.

For the purpose of transmitting the status information, the personal protection system 100 may be operable to detect different stages of the assembly of the personal protection system using, for example, conventional switches disposed throughout the personal protection system 100. Each of these switches is configured to communicate information concerning the status of at least a portion of the personal protection system 100 to the transceiver arrangement 805.

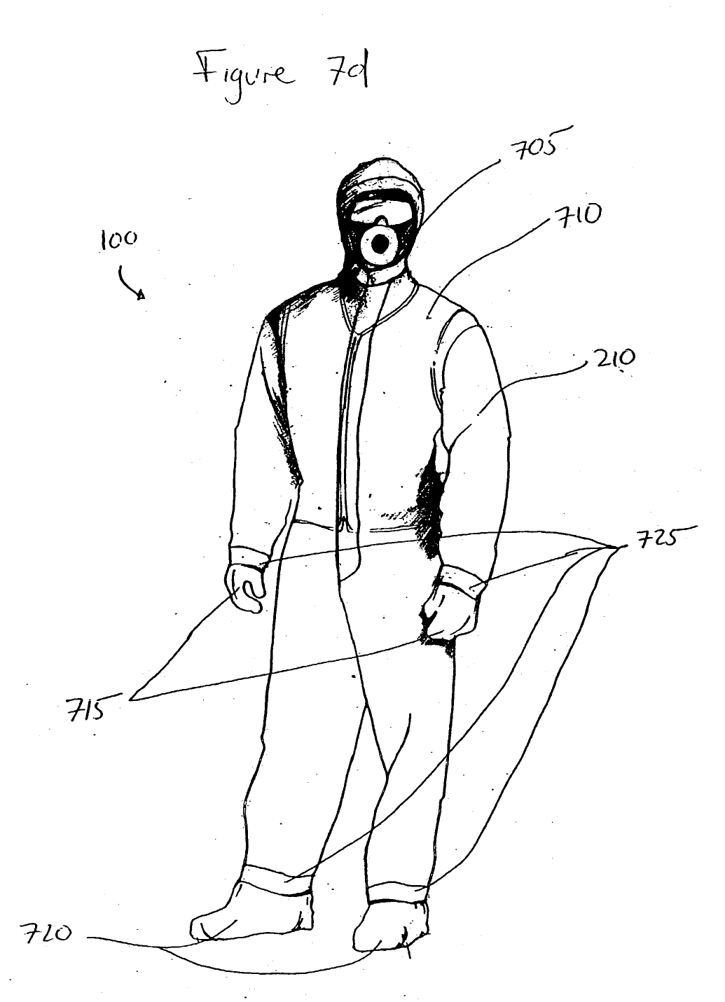

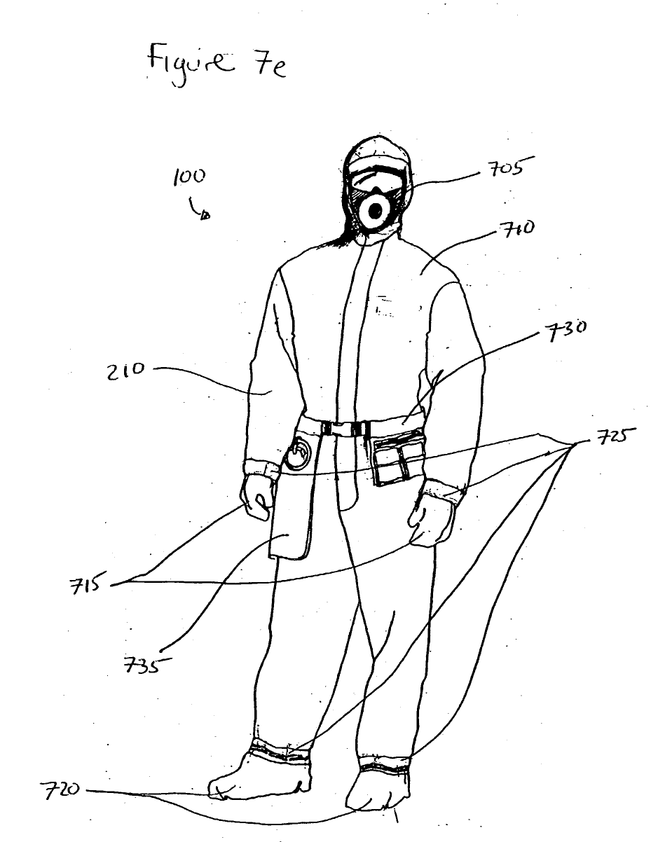

Referring now to FIGS. 9a and 9b, there is seen an exemplary switch 910 according to the present invention for communicating information concerning the status of a zipper arrangement 945 of the personal protection system 100. As shown in FIGS. 9a and 9b, the switch 910 includes first and second electrodes 915a, 915b, a pull-up lead 935 connected to both the first electrode and a voltage source 940, for example, 5 volts, a signal lead 930 connected to both the second electrode 915b and the transceiver arrangement 805, and a ground potential 925 connected to the signal lead 930 through a pull-down resistor 920.

In FIG. 9a, the zipper arrangement 945 is shown in an opened state, with electrodes 915a, 915b being electrically isolated. Thus, the potential of signal lead 930 is pulled to ground 925 via the pull-down resistor 920, thereby forcing the potential of the signal lead 930 to 0 volts.

In FIG. 9b, the zipper arrangement 945 is shown in a closed state, with electrodes 915a, 915b in electrical communication with one another. Thus, the potential of signal lead 930 is pulled to the voltage of the voltage source, for example, “5” volts, thereby forcing the potential of the signal lead 930 to “5” volts.

In this manner, the transceiver arrangement 805 may receive a signal indicating the state of the zipper arrangement 945 via the signal lead 930 (i.e., “0” volts for opened state; “5” volts for closed state) and may, for example, communicate information in accordance with the status of the zipper arrangement 945 to the remote location. Furthermore, similar switches may be incorporated throughout the personal protection system 100 to permit the transceiver arrangement 805, for example, to detect the removal/attachment of the protective shroud 117, to detect the removal/attachment of the external equipment 215, to detect the engagement/disengagement of the garment buckle 320, to detect the opening/closing of the pouch 120, to detect the folding/unfolding of the system garment 305, to detect the engagement/disengagement of the garment securing arrangement 440 of the system garment 305, to detect the removal/attachment of at least one of the system units 600a, 600b, 600c, . . . , 600n, to detect the preparing of the protective suit 710, etc.

As described above, the transceiver arrangement 805 may also be operable to wirelessly receive information from at least one remote transmission source. For example, the transceiver arrangement 805 may receive information signals to permit the transceiver arrangement 805 to determine its geographical position, such as, for example, Global Positioning Satellite (“GPS”) information signals from at least one GPS Satellite. By receiving these information signals, the transceiver arrangement 805 may, for example, determine the geographical position of the user 210, and then transmit the geographical position of the user 210 to the at least one remote location. In this manner, the observers located at the remote location(s) may monitor the position of at least one user 210 within the hazard zone.

It should be appreciated that the transceiver arrangement 805 may receive other information signals in addition to or in lieu of the information signals that enable the transceiver arrangement 805 to determine its geographical position. For example, the transceiver arrangement 805 may, for example, receive audio signals from the remote location, information for instructing the user 210 on how to proceed within the hazard zone, information concerning the location(s) of especially hazardous areas, information concerning the progress of other users 210 within the hazard zone, information concerning the location of supplies, such as, additional escape masks, water, etc.

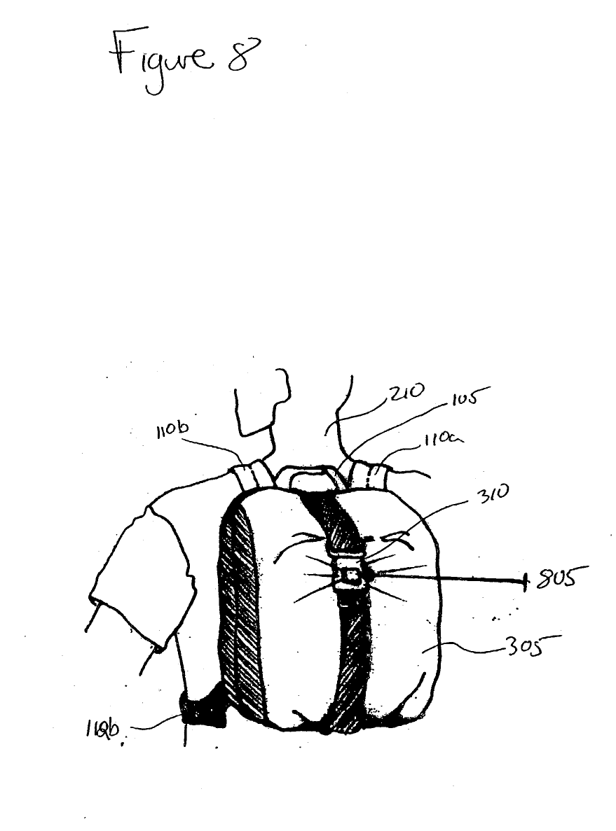

Referring now to FIG. 10, there is seen an exemplary transceiver arrangement 805 according to the present invention. Transceiver arrangement 805 includes an antenna arrangement 1005, a status switches arrangement 1015, a life signs detection arrangement 1030, a processing arrangement 1010, a data bus for communicatively coupling the antenna arrangement 1005, the status switches arrangement 1015, the life signs detection arrangement 1030, and the processing arrangement 1010, and a power source for providing electrical power to the transceiver arrangement 805.

The processing arrangement 1010 includes all circuitry operable to process signals received from the antenna arrangement 1005, the life signs detection arrangement 1030, and the status switches arrangement 1015, and to process signals for transmission to the remote location via the antenna arrangement 1005. The processing arrangement 1010 may include, for example, discrete logic circuits, a microprocessor, a microcomputer, and/or programmable logic (e.g., a Field Programmable Gate Array (“FPGA”) and/or an Application Specific Integrated Circuit (ASIC)), etc.

The antenna arrangement 1005 includes all circuitry operable to wirelessly transmit and receive information from and to at least one remote location. For this purpose, the antenna arrangement may include, for example, circuitry operable to communicate wireless information using a conventional modulation scheme, such as, for example, Quadrature Phase Shift Keying (QPSK), Phase Shift Keying (PSK), Amplitude Modulation (AM), Frequency Modulation (FM), Spread Spectrum, etc.

The status switches arrangement 1015 includes all circuitry operable to processes signals received from at least one status switch 1035 (e.g., switch 910 of zipper arrangement 945) of the personal protection system 100. The status switches arrangement 1015 may include, for example, discrete logic circuits, a microprocessor, a microcomputer, and/or programmable logic (e.g., a Field Programmable Gate Array (“FPGA”) and/or an Application Specific Integrated Circuit (ASIC)), etc. After processing the signal received from the status switches, the status switches arrangement 1015 communicates the processed signals to the processing arrangement 1010 via data bus 1025 for further processing, if necessary.

The life signs detection arrangement 1030 includes all circuitry operable to detect at least one life sign of the user 210 from life signs equipment (not shown) and communicate information in accordance with the at least one life sign to the processing arrangement 1010 via the data bus 1025. For example, the life signs detection arrangement 1030 may, for example, receive a heart rate, a breathing rate, a body temperature, a blood pressure, etc., from the life signs equipment. After receiving the information in accordance with the at least one life sign, the processing arrangement 1010 may communicate the life signs information to the at least one remote location via the antenna arrangement 1005.

It should be appreciated that, although FIG. 10 shows the antenna arrangement 1005, the status switches arrangement 1015, the life signs detection arrangement 1030, and the processing arrangement 1010 as separate functional units, the circuitry of these functional units may be included in any number of physical units distributed across a plurality of physical locations on the personal protection system 100.

It should also be appreciated that, although FIG. 10 shows a data bus 1025 operable to communicatively couple the antenna arrangement 1005, the status switches arrangement 1015, the life signs detection arrangement 1030, and the processing arrangement 1010, at least one other data communications medium may be employed. For example, in lieu of or in addition to the data bus 1025, the antenna arrangement 1005, the status switches arrangement 1015, and the processing arrangement 1010 may communicate information between each other using dedicated data lines (not shown).

Referring now to FIG. 11, there is seen an exemplary mask 1105 according to the present invention configured to be worn by the user 210 in a nuclear hazard zone, a chemical hazard zone, a biological hazard zone, and/or a radiological hazard zone. Mask 1105 includes a transparent window 1110 for permitting the user 210 to see, a first filter 1115 operable to filter out a first contaminant 1120 from an environmental atmosphere 1135, a second filter 1125 operable to filter out a second contaminant 1130 from the environmental atmosphere 1135, and a selection dial 1140 for selecting one or both of the filters 1115, 1125.

If used within a nuclear hazard zone, a chemical hazard zone, a biological hazard zone, and/or a radiological hazard zone, the mask 1105 permits the user to breathe the environmental atmosphere, after the atmosphere is filtered by one or both of the first and second filters 1115, 1125. Two different types of filters 1115, 1125 may be required, for example, to filter two different types of contaminants, such as, for example, a Carbon Monoxide (CO) contaminant filter 1115 and a Chemical-Biological-Radiological-Nuclear (CBRN) contaminant filter 1125 for filtering CO and at least one chemical, biological, radiological, and/or nuclear contaminant 1120, respectively. In this manner, for example, if the user 210 is operating within a CO contaminate hazard zone, the user 210 may receive a breathable atmosphere by breathing only through the CO contaminant filter 1115, whereas if the user 210 is operating within a chemical, biological, radiological, and/or nuclear hazard zone, the user 210 may receive a breathable atmosphere by breathing only through the CBRN contaminant filter 1125. If, however, the user 210 is operating in a zone that contains both types of contaminants, a single filter operable to remove a single type of contaminant from the atmosphere 1135 would not provide the user 210 with breathable air. In this case, the atmosphere 1135 would have to be filtered through both the CO contaminant filter 115 and the CBRN contaminant filter 1125 to ensure that the user 210 receives a breathable atmosphere.

For this purpose, the selection dial 1140 is operable to select one or both of the filters 1115, 1125. The selection dial 1140 includes three positions 1145a, 1145b, and 1145c for selecting the CO contaminant filter 1115, the CBRN contaminant filter 1125, or both the CO contaminant filter 1115 and the CBRN contaminant filter 1125, respectively. If position 1145a is selected, the user 210 receives a breathable atmosphere filtered only through the CO contaminant filter 1115, while the CBRN contaminant filter 1125 is blocked from filtering the atmosphere 1135. If position 1145b is selected, the user 210 receives a breathable atmosphere filtered only through the CBRN contaminant filter 1125, while the CO contaminant filter 1115 is blocked from filtering the atmosphere 1135. If position 1145c is selected, the user 210 receives a breathable atmosphere filtered through both the CO contaminant filter 1115 and the CBRN contaminant filter 1125.

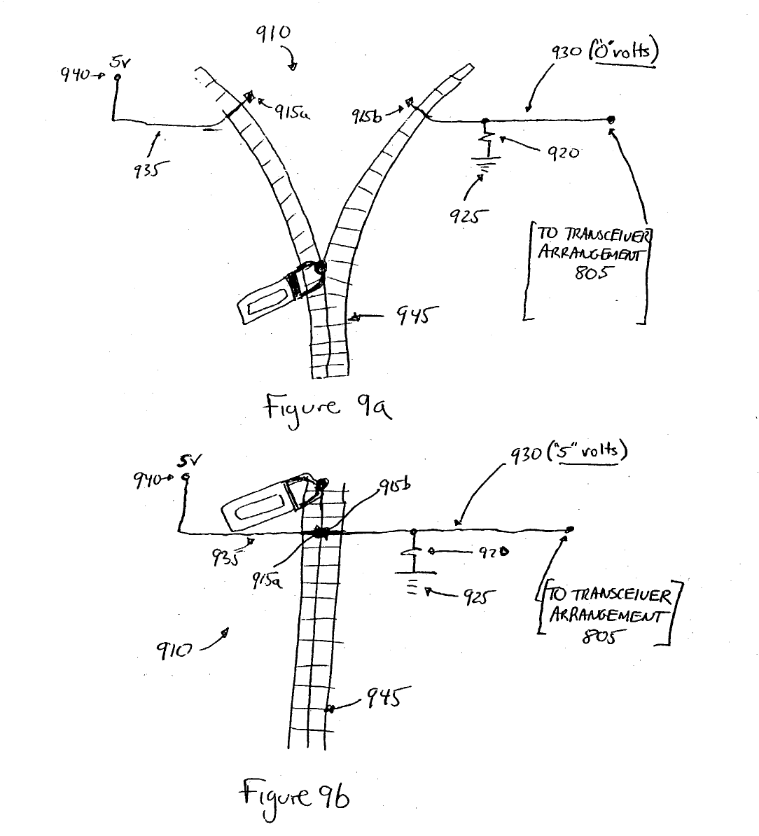

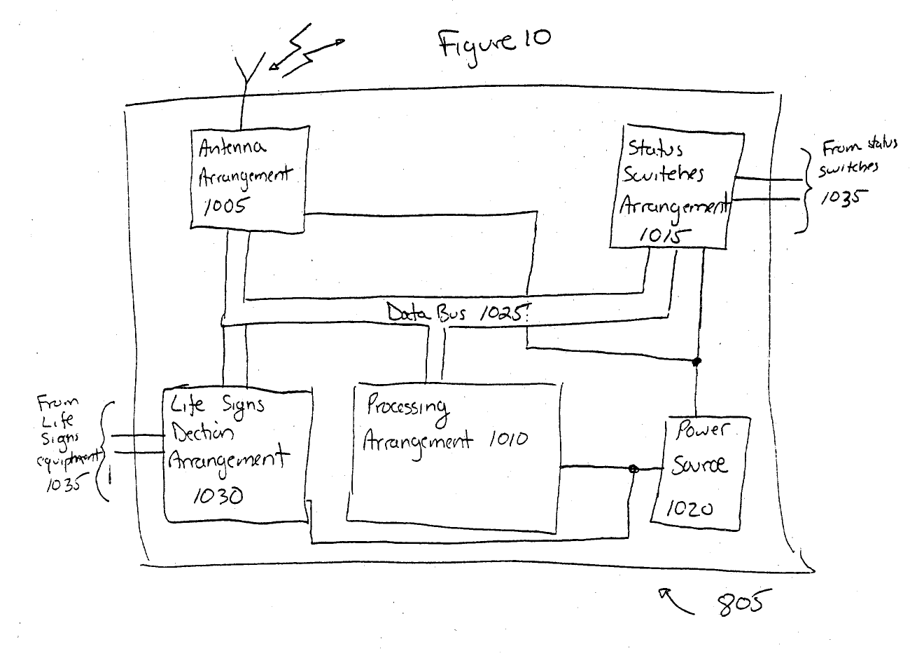

Referring now to FIG. 12a, there is seen an block diagram of the mask 1105 of FIG. 11. As shown in FIG. 12a, each of the CO contaminant filter 1115 and the CBRN contaminant filter 1125 includes a respective filter element 1205, 1210 for filtering a CO contaminant 1120 and a CBRN contaminant 1130, respectively. The mask 1105 includes atmosphere communication duct 1215a coupled to the CO contaminant filter 1115, atmosphere communication duct 1215b for coupling the CO contaminant filter 1115 with the CBRN contaminant filter 1125, and atmosphere communication duct 1215c coupled to the CBRN contaminant filter 1125. The mask 1105 also includes valves 1220a, 1220b, 1220c, . . . 1220e operable to be positioned into either a flow state or a blocked state for permitting the flow of atmosphere or blocking the flow of atmosphere, respectively.

When the selection dial 1140 is in position 1145a, valve 1220a is positioned to the flow state, while the remaining valves 1220b, 1220c, 1220d, and 1220e are positioned to the block state. In this manner, breathable atmosphere is filtered only through the filter element 1205 of the CO contaminant filter 1115 and into the mask interior 1225. When the selection dial 1140 is in position 1145b, valves 1220d and 1220e are positioned to the flow state, while the remaining valves 1220a, 1220b, 1220c, are positioned to the block state. In this manner, breathable atmosphere is filtered only through the filter element 1210 of the CBRN contaminant filter 1125 and into the mask interior 1225. When the selection dial 1140 is in position 1145c, valves 1220b, 1220c, and 1220e are positioned to the flow state, while the remaining valves 1220a and 1220d are positioned to the block state. In this manner, breathable atmosphere is filtered through both filter elements 1205, 1210 of the CO and CBRN contaminant filters 1115, 1125, respectively, and into the mask interior 1225.

It should be appreciated that although FIGS. 11 and 12a show mask 1105 with only two types of contaminant filters (i.e., a CO contaminant filter 1115 and a CBRN contaminant filter 1125), any number of contaminant filters may be employed, each of which is operable to filter out one or more types of contaminants. For example, mask 1105 may, for example, include three contaminant filters: a chemical contaminant filter, a radiological contaminant filter, and a biological contaminant filter. Or, mask 1105 may, for example, include four contaminant filters: a chemical contaminant filter, a radiological contaminant filter, a nuclear contaminant filter and a biological contaminant filter.

It should be appreciated that the selection dial 1140 may be operable to permit any combination of contaminant filters to filter the atmosphere 1135. For example, if mask 1105 includes four contaminant filters, the selection dial may include 15 positions to permit, for example, the following filtering combinations.

| switch | 1^{st} | 2^{nd} | 3^{rd} | 4^{th} |
|---|---|---|---|---|
| position | filter | filter | filter | filter |
| 1 | OFF | OFF | OFF | ON |
| 2 | OFF | OFF | ON | OFF |
| 3 | OFF | OFF | ON | ON |
| 4 | OFF | ON | OFF | OFF |
| 5 | OFF | ON | OFF | ON |
| 6 | OFF | ON | ON | OFF |
| 7 | OFF | ON | ON | ON |
| 8 | ON | OFF | OFF | OFF |
| 9 | ON | OFF | OFF | ON |
| 10 | ON | OFF | ON | OFF |
| 11 | ON | OFF | ON | ON |
| 12 | ON | ON | OFF | OFF |
| 13 | ON | ON | OFF | ON |
| 14 | ON | ON | ON | OFF |
| 15 | ON | ON | ON | ON |

It should also be appreciated that the mask 1105 may be equipped with a contaminant detection arrangement (not shown) for automatically detecting the types of contaminants contained within the atmosphere 1135 of the hazard zone. With information concerning the types of contaminants, the detection device may automatically position the selection dial 1140 into an appropriate position for filtering the detected contaminant combination. In this manner, dangers, which may occur as a result of the user 210 inadvertently selecting the wrong position on the selection dial 1140, may be avoided.

Referring now to FIG. 12b, there is seen another exemplary mask 1250 according to the present invention, including a single contaminant filter 1255 configure to filter a first and/or a second atmospheric contaminant. As seen in FIG. 12b, contaminant filter 1255 includes first and second contaminant filters 1260, 1265, each of which is rotatably mounted in a housing 1270 about center axis 1275 in the direction of arrows 1252, 1254, respectively. First and second filters 1260, 1265 include respective filter conduits 1290, 1295, and respective pass-through conduits 1256, 1258. Each of the filter conduits 1290, 1295 permits atmosphere to flow through a respective filter element (not shown) for filtering a particular type of contaminant, for example, CO and CBRN, whereas each of the pass-through conduits 1256, 1258 permits the atmosphere to pass through the respective filter 1260, 1265 without being filtered by the respective filter element (not shown).

Contaminant filter 1255 also includes first and second end plates 1280, 1285 fixedly mounted to the housing 1270 in a non-rotatable manner, the housing being fixedly mounted to the mask 1250. Each of plates 1280, 1285 includes a single off-center bore 1262, 1264, respectively, for permitting fluid communication with the atmosphere and the mask interior, respectively.

In operation, the contaminant filter 1255 is operable to permit the user 210 (not shown) to selectively filter the atmosphere using one or both of the first and second filters 1260, 1265. To permit the filter 1255 to filter the atmosphere using only the first filter 1260, the user rotates the first filter 1260, so that the filter conduit 1290 communicates with the off-center bore 1264 of end plate 1285, and rotates the second filter 1265, so that the pass-through bore 1258 communicates with the off-center bore of end plate 1280. In this manner, a fluid path is created, by which the atmosphere may pass from the atmosphere through the off-center bore 1264 of end plate 1285, through the filter conduit 1290 of the first filter 1260, through the pass-through bore 1258 of the second filter 1265, and into the mask interior through the off-center bore 1262 of the end plate 1280.

Alternatively, to permit the filter 1255 to filter the atmosphere using only the second filter 1265, the user rotates the first filter 1260, so that the pass-through bore 1256 communicates with the off-center bore 1264 of end plate 1285, and rotates the second filter 1265, so that the filter conduit 1295 communicates with the off-center bore 1262 of end plate 1280. In this manner, a fluid path is created, by which the atmosphere may pass from the atmosphere through the off-center bore 1264 of end plate 1285, through the pass-through bore 1256 of the first filter 1260, through the filter conduit 1295 of the second filter 1265, and into the mask interior through the off-center bore 1262 of the end plate 1280.

Alternatively, to permit the filter 1255 to filter the atmosphere using both the first and second filters 1260, 1265, the user rotates the first filter 1260, so that the filter conduit 1290 communicates with the off-center bore 1264 of end plate 1285, and rotates the second filter 1265, so that the filter conduit 1295 communicates with the off-center bore 1262 of end plate 1280. In this manner, a fluid path is created, by which the atmosphere may pass from the atmosphere through the off-center bore 1264 of end plate 1285, through the filter conduit 1290 of the first filter 1260, through the filter conduit 1295 of the second filter 1265, and into the mask interior through the off-center bore 1262 of the end plate 1280.

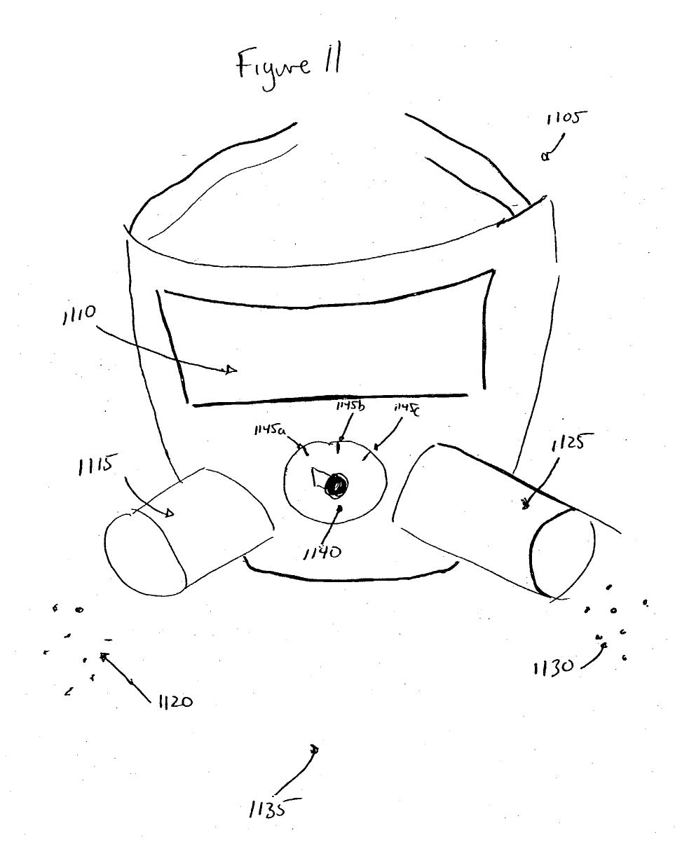

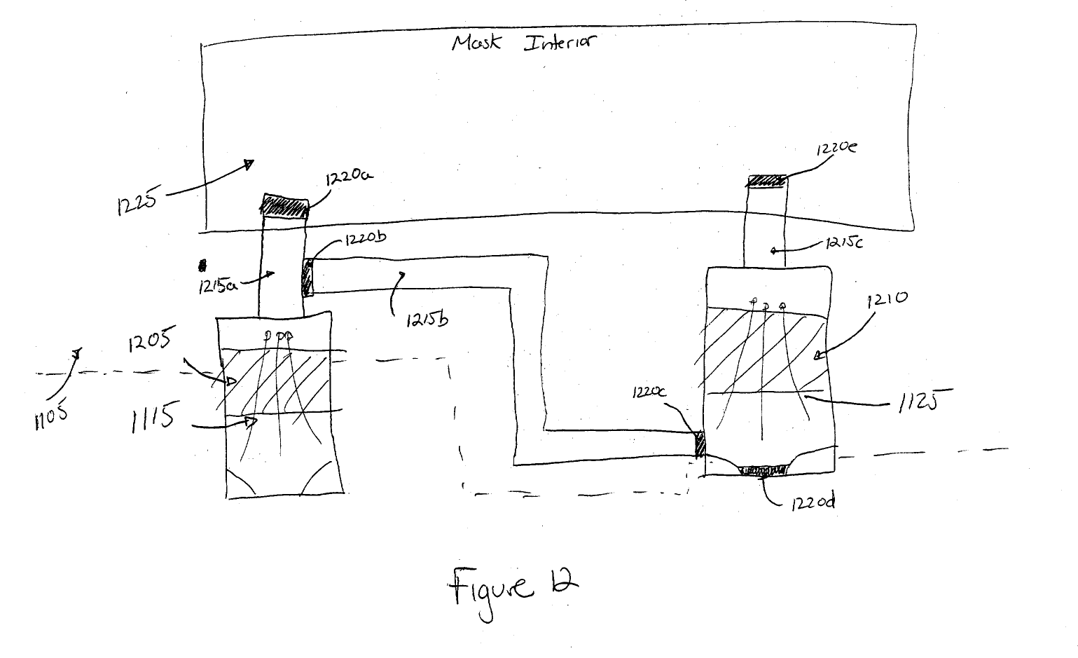

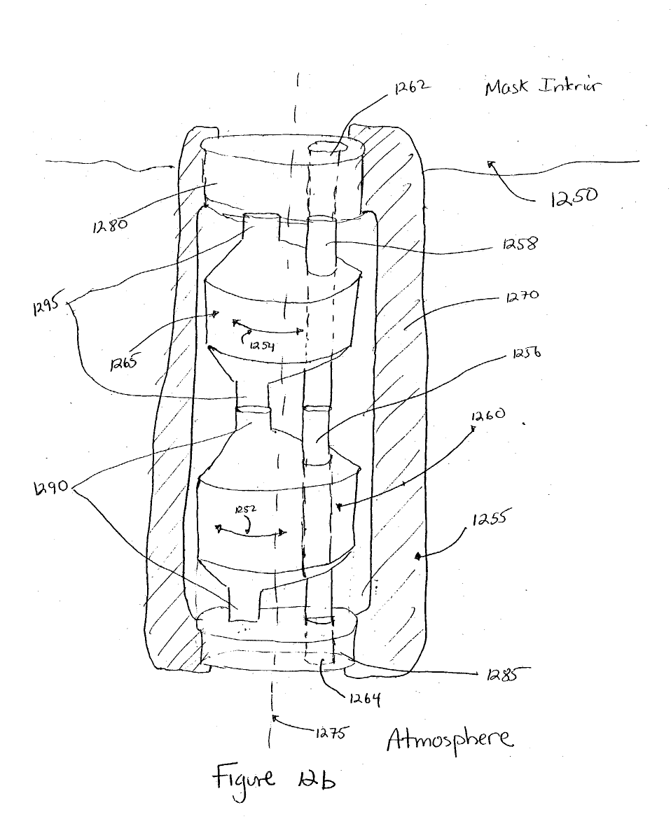

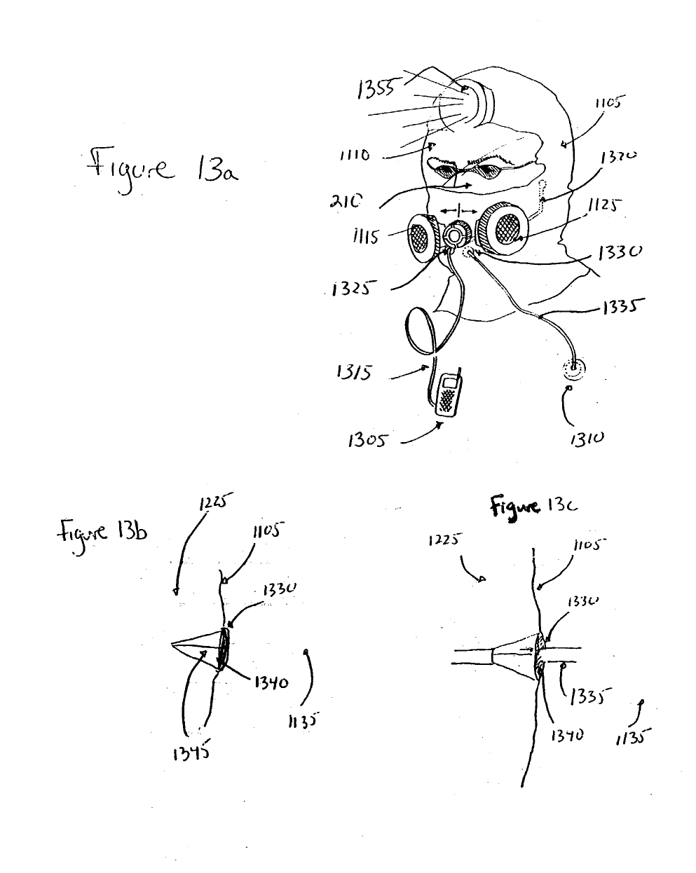

Referring to FIG. 13a, there is seen the exemplary mask 1105 of FIG. 11 configured to connect to a personal communications device 1305 and/or a personal drinking supply 1310. The exemplary mask 1105 of FIG. 13 also includes an optional light source 1355 to be discussed in further detail below.

Arranged within the mask 1105, is a headphone and speaker arrangement 1320 operable to permit the user 210 to communicate audibly with at least one other person via the personal communications device 1305. For this purpose, the headphone and speaker arrangement 1320 is either detachably or permanently connected to communications jack 1325 within the mask interior 1225 in an airtight manner.

A communications cable 1315 is provided to permit an electrical and communicative connection between the personal communications device 1305 and the headphone and speaker arrangement 1320 via the communications jack 1325. For this purpose, the communications cable 1315 is configured to detachably and communicatively couple to the personal communications device 1305 and/or the communications jack 1325. In this manner, the user 210 may communicate via the personal communications device 1305 without having to remove the mask 1105 and without danger that external contaminants may penetrate the interior 1225 of the mask 1105, since the communications jack 1325 is configured to permit electrical communications without permitting the external atmosphere 1135 to enter the interior 1225 of the mask 1105.

Alternatively, it should be appreciated that the headphone and speaker arrangement 1320 may wirelessly communicate with the personal communications device 1305, thereby obviating the need for the communications jack 1325.

The communications device 1305 may include any device operable to permit the user 210 to communicate with at least one other person. For example, the communications device 1305 may include a cell phone, a two-way radio, a walkie-talkie, a ham radio, etc.

The mask 1105 may also include a drinking supply jack 1330 operable to connect to a portable drinking supply 1310 via a drinking tube 1335 to permit the user 210 to drink from the supply 1310 without having to remove the mask 1105 and without permitting the external atmosphere 1135 to enter the interior 1225 of the mask 1105. In this manner, the user 210 inserts the drinking tube 1135 into the interior 1225 of the mask 1105 through the drinking supply jack 1330.

Referring to FIGS. 13b and 13c, there is seen an exemplary drinking supply jack 1330 according to the present invention. As seen in FIG. 13b, the drinking supply jack 1330 includes at least one flexible flap 1345 biased against an opening 1340 of the jack 1330 in an airtight manner. In this way, the external atmosphere 1135 is prevented from entering the interior 1225 of the mask 1105 when the drinking tube 1335 is not inserted through the drinking supply jack 1330.

Referring to FIG. 13c, there is seen the exemplary drinking supply jack 1330 of FIG. 13b receiving the drinking tube 1335. As seen in FIG. 13c, the at least one flexible flap 1345 frictionally engages the drinking tube 1335 in an airtight manner as it is inserted into the interior 1225 of the mask 1105. In this way, the external atmosphere 1135 is prevented from entering the interior 1225 of the mask 1105 when the drinking tube 1335 is inserted through the drinking supply jack 1330.

Referring to FIG. 13d, there is seen another exemplary drinking supply jack 1330 according to the present invention. As seen in FIG. 13d, the drinking supply jack 1330 includes a drinking straw 1350 arranged within the interior 1225 of the mask 1105 in a permanently airtight manner. In this embodiment, the drinking tube 1335 may be frictionally and detachably engaged within the opening 1340 of the drinking supply jack 1330. In this manner, the user 210 may drink from the drinking supply 1310 without exposing the interior 1225 of the mask 1105 to the external atmosphere 1135.

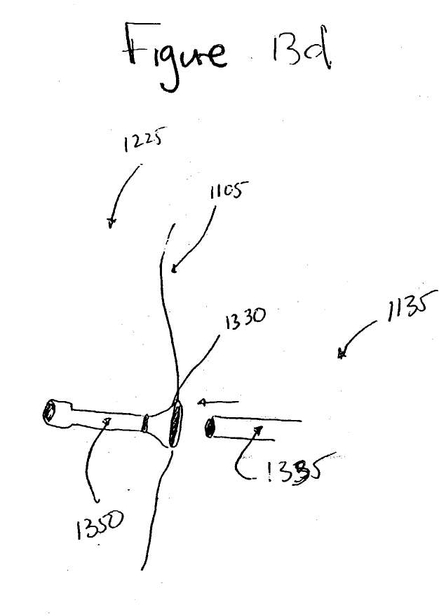

Referring now to FIG. 14, there is seen an exemplary mask 1405 including an adjustable light source 1410 operable to provide illumination of the environment. The light source 1410 may be either permanently or detachably securable to the mask and may be piviotable along arrow 1415 to allow adjustment of the light source 1410 by user 210.

In one exemplary embodiment according to the present invention, a light source arrangement (not shown) of a flashlight (not shown) may be disconnected from the flashlight and connected to the exemplary mask 1405 as the adjustable light source 1410. In this manner, a power source (not shown) attached to the mask 1405 may provide power to the adjustable light source 1410 once attached to the mask 1405.

What is claimed is:

1. A personal protection system, comprising:
a backpack configured to couple to a user, the backpack including a system garment fixedly coupled to the backpack, wherein the system garment includes at least one system unit operable to at least partially aid the user in at least one of a biological hazard, a nuclear hazard, a chemical hazard, and a radiological hazard.

2. The personal protection system according to claim 1, wherein the backpack includes at least one harness strap configured to couple to the user.

3. The personal protection system according to claim 1, wherein the at least one system unit includes at least one of a Nuclear-Biological-Chemical-Radiological escape mask, a smoke escape mask, a nuclear gas mask, a gas mask filter, a protective suit, a pair of protective gloves, a pair of protective booties, a roll of tape, a flashlight, radiation blocking pills, at least one gas detection device, at least one radiation detection device, a water purifier, a first-aid kit, a two-way radio device, a cell phone, a rescue whistle, at least one light-stick, a compass, an AM/FM radio, a safety horn, at least one writing utensil, waterproof matches, a utility belt, a parachute, and a portable drinking supply.

4. The personal protection system according to claim 3, wherein the portable drinking supply includes a “Camel-Bak” drinking supply.

5. The personal protection system according to claim 1, further comprising:
a protective shroud, wherein the backpack further includes a pouch configured to contain the protective shroud.

6. The personal protection system according to claim 5, wherein at least a portion of the protective shroud is fixedly coupled to one of the backpack and the system garment.

7. The personal protection system according to claim 5, wherein the protective shroud is provided with an identifying color to identify a type of equipment contained within the backpack.

8. The personal protection system according to claim 5, wherein the protective shroud is provided to identify an institution.

9. The personal protection system according to claim 5, wherein the protective shroud is at least one of fireproof and bulletproof.

10. The personal protection system according to claim 5, wherein the backpack includes at least one harness strap configured to couple to the user.

11. The personal protection system according to claim 5, wherein the system garment is fixedly secured to the backpack in a space-saving manner.

12. The personal protection system according to claim 5, wherein the at least one system unit includes at least one of a Nuclear-Biological-Chemical-Radiological escape mask, a smoke escape mask, a nuclear gas mask, a gas mask filter, a protective suit, a pair of protective gloves, a pair of protective booties, a roll of tape, a flashlight, radiation blocking pills, at least one gas detection device, at least one radiation detection device, a water purifier, a first-aid kit, a two-way radio device, a cell phone, a rescue whistle, at least one light-stick, a compass, an AM/FM radio, a safety horn, at least one writing utensil, waterproof matches, a utility belt, a parachute, and a portable drinking supply.

13. The personal protection system according to claim 12, wherein the portable drinking supply includes a “Camel-Bak” drinking supply.

14. The personal protection system according to claim 1, further comprising:
an external equipment fastening arrangement configured to detachably couple to at least one piece of external equipment.

15. The personal protection system according to claim 14, wherein the external equipment includes a bag.

16. The personal protection system according to claim 1, further comprising:
a transceiver arrangement configured to wirelessly communicate information with at least one remote location.

17. The personal protection system according to claim 16, wherein the transceiver is configured to transmit status information to the at least one remote location.

18. The personal protection system according to claim 17, wherein the status information includes at least one of the geographical location of the user, life signs of the user, a hazard level, a hazard type, and emergency information.

19. The personal protection system according to claim 17, wherein the status information includes information concerning a progress sequence of preparing the personal protection system.

20. The personal protection system according to claim 16, wherein the transceiver arrangement is configured to receive information concerning a geographical location of the personal protection system from at least one GPS satellite.

21. A transceiver arrangement, comprising:
an antenna arrangement; and
a processing arrangement communicatively coupled to the antenna arrangement, the processing arrangement configured to wirelessly communicate information with at least one remote location; wherein a transmission is started in accordance with at least one status switch of a personal protection system.

22. The transceiver arrangement according to claim 21, wherein the processing arrangement is configured to transmit status information to the at least one remote location via the antenna arrangement.

23. The transceiver arrangement according to claim 22, wherein the status information includes at least one of the geographical location of the user, life signs of the user, a hazard level, a hazard type, and emergency information.

24. The transceiver arrangement according to claim 22, wherein the status information includes information concerning a progress sequence of preparing the personal protection system.

25. The transceiver arrangement according to claim 21, wherein the processing arrangement is configured to receive information concerning a geographical location of the personal protection system from at least one GPS satellite via the antenna arrangement.

26. The personal protection system according to claim 1, further comprising:
a protective suit fixedly coupled to the system garment.

27. The personal protection system according to claim 1, further comprising:
a system unit bag coupled to the system garment.

28. The personal protection system according to claim 27, wherein the bag is detachably coupleable to the system garment.

29. The personal protection system according to claim 27, wherein the system unit bag includes at least one compartment for carrying at least one of the system units.

30. The personal protection system according to claim 29, wherein at least one of the compartments is vacuum sealed.

31. A method of protecting a user from at least one of a biological hazard, a chemical hazard, a nuclear hazard, and a radiological hazard, the method comprising:
providing a user with a personal protection system, the personal protection system including a system garment fixedly coupled to a backpack, the system garment including at least one system unit operable to at least partially aid the user in the at least one of the biological hazard, the chemical hazard, the nuclear hazard, and the radiological hazard;
reconfiguring the system garment from a space-saving state to an unpackaged state;
reconfiguring the system garment from the unpackaged state to a wearable state; and
supplying the user with the at least one system unit.

32. The method according to claim 31, wherein the at least one system unit includes at least one of a Nuclear-Biological-Chemical escape mask, a smoke escape mask, a nuclear gas mask, a gas mask filter, a protective suit, a pair of protective gloves, a pair of protective booties, a roll of tape, a flashlight, radiation blocking pills, at least one gas detection device, at least one radiation detection device, a water purifier, a first-aid kit, a two-way radio device, a cell phone, a rescue whistle, at least one light-stick, a compass, an AM/FM radio, a safety horn, at least one writing utensil, waterproof matches, a utility belt, a parachute, and a portable drinking supply.

33. The method according to claim 32, wherein the step of supplying the user with the at least one system unit includes the following sub-steps:
a) supplying the user with a protective mask;
b) supplying the user with a protective suit;
c) supplying the user with a pair of gloves and a pair of booties; and
d) taping the gloves and the booties to the protective suit.

34. The method according to claim 33, wherein the sub-steps further include the sub-step of providing the user with a utility belt.

35. The method according to claim 34, wherein the utility belt includes a drinking supply.

36. A mask for filtering an atmosphere, comprising:
at least two contaminant filters; and
a selection arrangement for selecting a combination of the contaminant filters; wherein the combination includes at least one of the contaminant filters, and the atmosphere is filtered through the combination of contaminant filters.

37. The mask according to claim 36, further comprising:
an adjustable light source manually pivotable into at least one position.

38. The mask according to claim 36, further comprising:
a communications jack; and
a headphone and speaker arrangement one of detachably and permanently connected to the communications jack in an airtight manner.

39. The mask according to claim 36, further comprising:
a drinking supply jack configured to connect to a portable drinking supply in an airtight manner.

40. A mask, comprising:
at least one contaminant filter;
a communications jack; and
a headphone and speaker arrangement one of detachably and permanently connected to the communications jack in an airtight manner.

41. The mask according to claim 40, further comprising:
a drinking supply jack configured to connect to a portable drinking supply in an airtight manner.

42. A protective garment, comprising:
a protective suit, including booties, gloves, and a mask; wherein the booties, the gloves, and the mask are fixedly secured to the protective suit.

43. The protective suit according to claim 42, further comprising:
at least one adjustable strap to adjust at least one of the booties and the gloves.

44. The mask according to claim 36, further comprising
a contaminant detection arrangement to detect at least one type of contaminant within the atmosphere; wherein the contaminant detection arrangement is configured to automatically select the combination of the contaminant filters in accordance with the detected type of contaminants.

45. The mask according to claim 36, wherein the at least two contaminant filters are arranged within a single filter housing.

46. The mask according to claim 36, wherein the at least two contaminant filters include a CO filter and a CBRN filter.

47. A mask, comprising:
at least one contaminant filter; and
a headphone and speaker arrangement situated within an interior of the gas mask and configured to wirelessly communicate with at least one personal communications device; wherein the personal communications device is configured to wirelessly communicate with at least one remote location.
